(19) United States
(12) Patent Application Publication
(10) Pub. No.: US 2013/0252029 A1
(43) Pub. Date: Sep. 26, 2013

(54) MAGNETIC RECORDING MEDIUM AND METHOD OF MANUFACTURING THE SAME

(71) Applicants: Kazutaka Takizawa, Kawasaki-shi (JP); Akira Watanabe, Kawasaki-shi (JP); Kaori Kimura, Yokohama-shi (JP); Akihiko Takeo, Kunitachi-shi (JP)

(72) Inventors: Kazutaka Takizawa, Kawasaki-shi (JP); Akira Watanabe, Kawasaki-shi (JP); Kaori Kimura, Yokohama-shi (JP); Akihiko Takeo, Kunitachi-shi (JP)

(73) Assignee: Kabushiki Kaisha Toshiba, Tokyo (JP)

(21) Appl. No.: 13/599,569

(22) Filed: Aug. 30, 2012

(30) Foreign Application Priority Data
Mar. 23, 2012 (JP) 2012-068103

(51) Int. Cl. G11B 5/84; G11B 5/74

(52) U.S. Cl. 428/800; 427/130

(57) ABSTRACT

In a removing step, a phase-separated release solution including a first phase containing a first solvent capable of dissolving a release layer and a second phase containing a second solvent having a property of separating from the first solvent is prepared, and a patterned magnetic recording medium is dipped in the first phase together with a release layer, mask layer, and resist layer remaining on a magnetic recording layer, thereby removing the release layer. After that, the patterned magnetic recording medium is moved to the second phase, and separated from the first phase containing the release layer and the layers remaining on the release layer.

### CROSS-REFERENCE TO RELATED APPLICATIONS

This application is based upon and claims the benefit of priority from Japanese Patent Application No. 2012-068103, filed Mar. 23, 2012, the entire contents of which are incorporated herein by reference.

### FIELD

Embodiments described herein relate generally to a magnetic recording medium and a method of manufacturing the same.

### BACKGROUND

Recently, the amount of information to be processed by information communication apparatuses is constantly increasing, and strong demands have arisen for implementing a large-capacity information recording device. As hard disk drive (HDD) techniques, the development of various techniques such as perpendicular magnetic recording has advanced to increase the recording density. In addition, a discrete track medium and bit patterned medium have been proposed as media capable of increasing both the recording density and thermal fluctuation resistance, and it is of urgent necessity to develop the manufacturing techniques of these media.

To record one-bit information in one cell as in the bit patterned medium, it is only necessary to magnetically isolate individual cells. In many cases, therefore, magnetic dot portions and nonmagnetic dot portions are formed in the same plane based on a micropatterning technique. Alternatively, the magnetism of a recording medium is selectively deactivated by injecting different types of ionized elements. In either case, a general approach is to use micropatterns.

More specifically, a magnetic recording layer formed on a substrate is patterned by applying a semiconductor manufacturing technique so as to isolate a magnetic region and nonmagnetic region. A patterning mask for transferring fine three-dimensional patterns is formed on the magnetic recording layer, and a three-dimensional structure is formed on the patterning mask and transferred to the magnetic recording layer, thereby obtaining a magnetic recording medium in which three-dimensional patterns are isolated.

The three-dimensional structure is formed on the mask pattern by using a versatile resist material of semiconductor fabrication. Examples are a method of obtaining desired patterns by selectively modifying the resist material by irradiation with an energy line, a method of patterning a self-organized film formed by arranging patterns having different chemical properties in the resist film, and a method of patterning by physically pressing a three-dimensional template. There is still another method by which after a three-dimensional structure is formed on mask patterns, ions irradiated with high energy are implanted into a magnetic recording layer to selectively deactivate the magnetism of the patterns, thereby obtaining a magnetically isolated medium.

When a magnetic head for performing write or read to a magnetic recording medium is scanned on it, head crash occurs if mask patterns remain on a magnetic recording layer because projections as magnetic dots are high. Also, if the distance between the magnetic recording layer and magnetic head is not large, an S/N ratio detectable by the magnetic head decreases. After the magnetic recording layer is patterned, therefore, the projections must be lowered by removing the mask patterns on the magnetic recording layer. In an actual process, a release layer is generally formed between the magnetic recording layer and mask layer. It is possible, by removing this release layer, to remove the mask layer from the surface of the magnetic recording layer and improve the flatness of the medium.

An example of the patterned medium release process is a process of removing a metal film as a release layer by using an acid. Another example is a method of removing a Si-containing polymer as a release layer by using an organic solvent. In this method, however, the removed mask is liberated as dust in the solution and redeposited on the medium, thereby decreasing the flatness. This deteriorates the HDI (Head Disk Interface) characteristic. Also, if the thickness of the release layer changes from one position to another, the removal time must be prolonged, and the magnetic characteristics deteriorate because the time during which the magnetic recording layer is exposed to the release solution prolongs.

### BRIEF DESCRIPTION OF THE DRAWINGS

FIGS. 1A, 1B, 1C, 1D, 1E, 1F, and 1G are views showing an example of a perpendicular magnetic recording medium manufacturing method according to the first embodiment of the present invention;

FIGS. 2A, 2B, 2C, 2D, 2E, 2F, 2G, and 2H are views showing an example of a perpendicular magnetic recording medium manufacturing method according to the second embodiment;

FIGS. 3A, 3B, 3C, 3D, 3E, 3F, 3G, and 3H are views showing an example of a magnetic recording medium manufacturing method using self-organization lithography;

FIGS. 4A, 4B, 4C, 4D, 4E, 4F, 4G, 4H, and 4I are views showing an example of a magnetic recording medium manufacturing method using nanoimprinting;

FIG. 5 is an exemplary view showing an example of a phase-separated release solution for use in an embodiment;

FIGS. 6A, 6B, 6C, 6D, and 6E are exemplary views showing an example of a removing step according to an embodiment;

FIGS. 7A, 7B, 7C, and 7D are exemplary views showing the way a sample is pulled up to a second solvent;

FIGS. 8A, 8B, and 8C are exemplary views showing an example of the phase-separated state of the release solution;

FIG. 9 is a view showing examples of recording bit patterns of a magnetic recording medium;

FIG. 10 is a view showing another example of the recording bit patterns of the magnetic recording medium;

FIG. 11 is a view showing an example of the arrangement of a cleaning apparatus applicable to an embodiment;

FIG. 12 is a view showing another example of the arrangement of the cleaning apparatus applicable to an embodiment;

FIG. 13 is a view showing a part of the operation of the cleaning apparatus shown in FIG. 11;

FIG. 14 is a view showing another part of the operation of the cleaning apparatus shown in FIG. 11;

FIG. 15 is a view showing an example of a mechanism for loading a sample into the cleaning apparatus;

FIG. 16 is a view showing another example of the mechanism for loading a sample into the cleaning apparatus; and

FIG. 17 is a view showing still another example of the mechanism for loading a sample into the cleaning apparatus.

### DETAILED DESCRIPTION

A magnetic recording medium manufacturing method according to an embodiment includes steps of

forming an unprocessed magnetic recording medium by forming a magnetic recording layer on a substrate,

forming a release layer on the magnetic recording layer,

forming a mask layer on the release layer,

forming a resist layer on the mask layer,

forming three-dimensional patterns on the resist layer,

transferring the three-dimensional patterns to the mask layer,

transferring the three-dimensional patterns to the release layer,

transferring the three-dimensional patterns to the magnetic recording layer, and

removing the release layer and removing layers remaining on the release layer, thereby obtaining a patterned magnetic recording medium.

In the removing step, a phase-separated release solution including a first phase containing a first solvent capable of dissolving the release layer and a second phase containing a second solvent having a property of separating from the first solvent is prepared. First, the patterned magnetic recording medium is dipped in the first phase together with the release layer, mask layer, and resist layer remaining on the magnetic recording layer, thereby removing the release layer, and removing the mask layer formed on the release layer, and the resist layer. After that, the patterned magnetic recording medium is moved to the second phase, and separated from the first phase containing the release layer and the layers remaining on the release layer.

In the embodiment, the phase-separated release solution contains two or more types of separated solvents. Also, the release layer is selected from materials soluble in one of the separated release solutions. Furthermore, since the patterned magnetic recording medium is passed through the interface between the separated solutions, the release layer can be removed as it is physically scraped off from the surface of the patterned magnetic recording layer by one of the solvents.

The magnetic recording medium manufacturing method according to the embodiment uses the phase-separated release solution containing two or more types of separated solvents, dust particles caused by the mask layer removed from the surface of the magnetic recording layer of the magnetic recording medium can be trapped in the first phase, and this makes is possible to prevent the redeposition of the dust particles to the magnetic recording medium having moved to the second phase, thereby improving the HDI characteristic of the medium. Although physical cleaning using a brush or the like increases cleaning scratches on the medium, physical removal using solvents can extremely reduce cleaning scratches. Also, since physical removal is performed using the interface between the separated solutions, the release layer can be removed from the surface of the magnetic recording layer although the release layer is not completely dissolved. Accordingly, the thickness of the release layer can be decreased. Furthermore, the difference in release layer thickness between positions causes in-plane unevenness of patterns after removal. However, the dissolution and physical removal of the release layer decrease the in-plane unevenness of patterns.

As the release layer, it is possible to select a material soluble in the first solvent and sparingly soluble in the second solvent.

The phase-separated release solution can contain one of an acid solvent, alkali solvent, and organic solvent.

The resist layer can be a self-organized film having at least two different types of polymer chains.

The three-dimensional patterns of the resist layer can be formed by nanoimprinting.

A pattern transfer layer can further be formed between the mask layer and resist layer.

The embodiment also provides a magnetic recording medium formed by the above-mentioned method.

The embodiment will be explained in more detail below with reference to the accompanying drawings.

The magnetic recording medium manufacturing method according to the embodiment includes the following two methods.

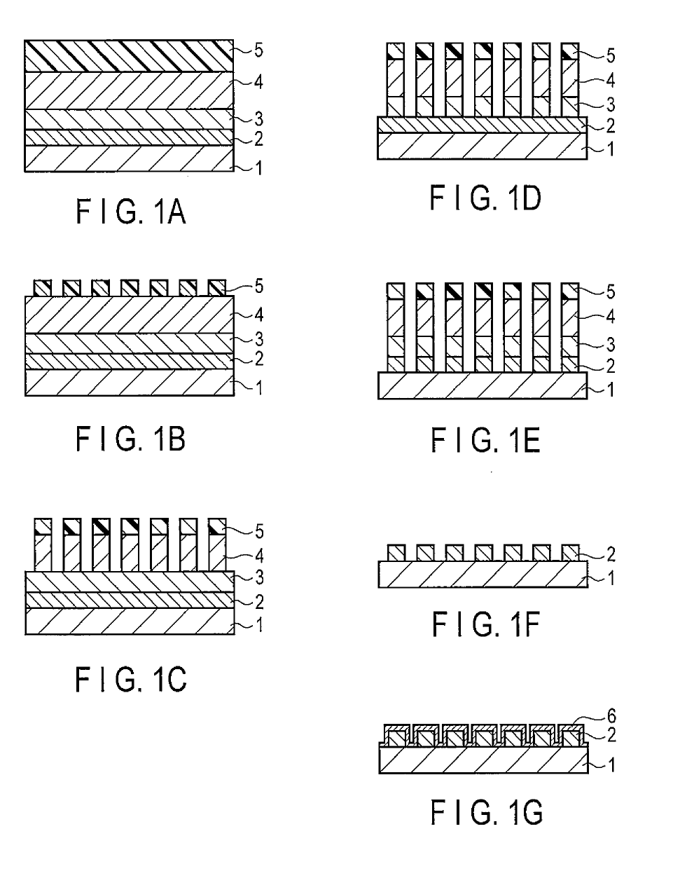

FIGS. 1A, 1B, 1C, 1D, 1E, 1F, and 1G show an example of a perpendicular magnetic recording medium manufacturing method according to the first embodiment.

The magnetic recording medium manufacturing method according to the first embodiment includes a step of obtaining an unprocessed magnetic recording medium by forming a magnetic recording layer 2 on a substrate 1, a step of forming a release layer 3 on the magnetic recording layer 2, a step of forming a mask layer 4 on the release layer 3, and a step of forming a resist layer 5 on the mask layer 4 as shown in FIG. 1A, a step of forming three-dimensional patterns in the resist layer 5 as shown in FIG. 1B, a step of transferring the three-dimensional patterns to the mask layer 4 as shown in FIG. 1C, a step of transferring the three-dimensional patterns to the release layer 3 as shown in FIG. 1D, a step of transferring the three-dimensional patterns to the magnetic recording layer 2 as shown in FIG. 1E, a step of dipping the magnetic recording medium including the patterned magnetic recording layer 2 and substrate 1, together with the release layer 3, mask layer 4, and resist layer 5 remaining on the magnetic recording layer 2, in a first phase, which can dissolve the release layer 3, of a phase-separated release solution, thereby dissolving the release layer 3, and removing the residual layers 4 and 5, and a step of moving the magnetic recording medium to a second phase and separating the magnetic recording medium from the release layer 3 and the removed layers 4 and 5, thereby obtaining a patterned magnetic recording medium as shown in FIG. 1F. In addition, a protective layer 6 can be formed on the magnetic recording layer 2 as shown in FIG. 1G.

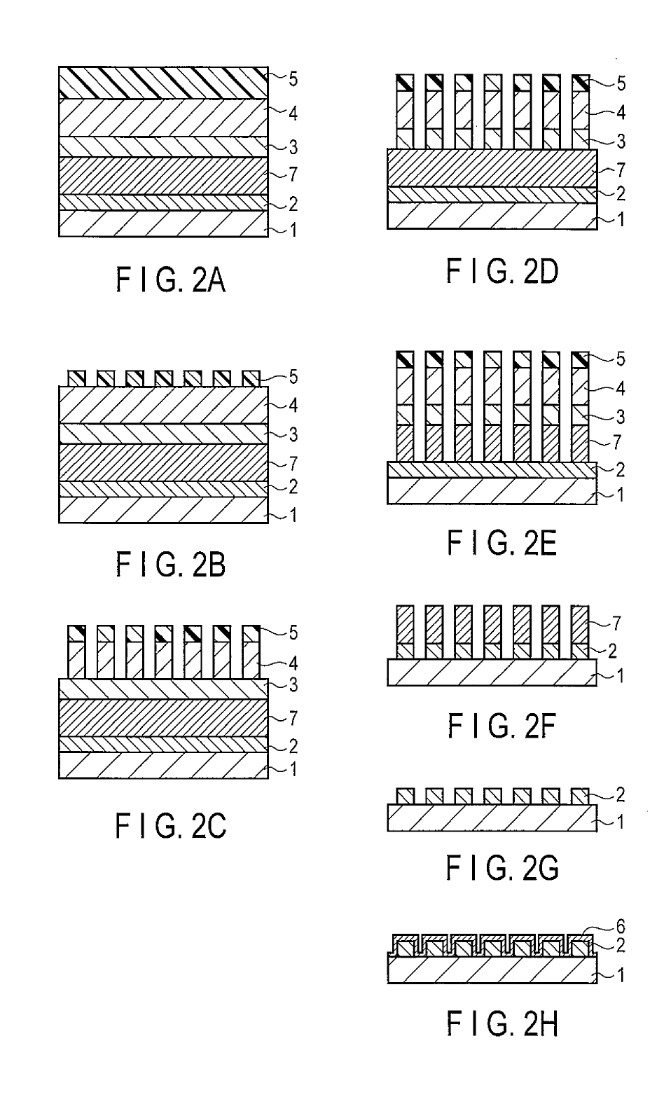

FIGS. 2A, 2B, 2C, 2D, 2E, 2F, 2G, and 2H show an example of a perpendicular magnetic recording medium manufacturing method according to the second embodiment.

The magnetic recording medium manufacturing method according to the second embodiment includes a step of forming a first mask layer 7 as an additional mask layer on a magnetic recording layer 2 before a release layer 3 is formed, a step of forming the release layer 3 on the first mask layer 7, a step of forming a second mask layer 4 on the release layer 3, and a step of forming a resist layer 5 on the second mask layer 4 as shown in FIG. 2A, a step of forming three-dimensional patterns on the resist layer 5 as shown in FIG. 2B, a step of transferring the three-dimensional patterns to the second mask layer 4 as shown in FIG. 2C, a step of transferring the three-dimensional patterns to the release layer 3 as shown in FIG. 2D, a step of transferring the three-dimensional patterns to the first mask layer 7 as shown in FIG. 2E, a step of transferring the three-dimensional patterns to the magnetic recording layer 2, a step of dipping the magnetic recording medium including the patterned magnetic recording layer 2 and substrate 1, together with the first mask layer 7, release layer 3, second mask layer 4, and resist layer 5 remaining on the magnetic recording layer 2, in a first phase, which can dissolve the release layer 3, of a phase-separated release solution, thereby dissolving the release layer 3, and removing the layers 4, 5, and 6 remaining on the release layer 3, and a step of moving the magnetic recording medium having the first mask layer 7 to a second phase and separating the substrate from the release layer 3 and the removed layers 4, 5, and 6, thereby obtaining a patterned magnetic recording medium having the mask layer 7 as shown in FIG. 2F. In addition, it is possible to remove the first mask layer by dry etching or wet etching as shown in FIG. 2G, and form a protective layer 6 on the magnetic recording layer 2 as shown in FIG. 2H.

In the second embodiment, the first mask layer 7 can be selected from materials that can increase the etching selectivity to the second mask layer 4.

Furthermore, a perpendicular magnetic recording medium according to an embodiment can be formed by using the perpendicular magnetic recording medium manufacturing method according to the first or second embodiment.

Examples of the method of forming the three-dimensional patterns in the resist layer are lithography using an energy line, nanoimprinting, and patterning using a self-organized film made of a block copolymer having at least two types of polymer chains.

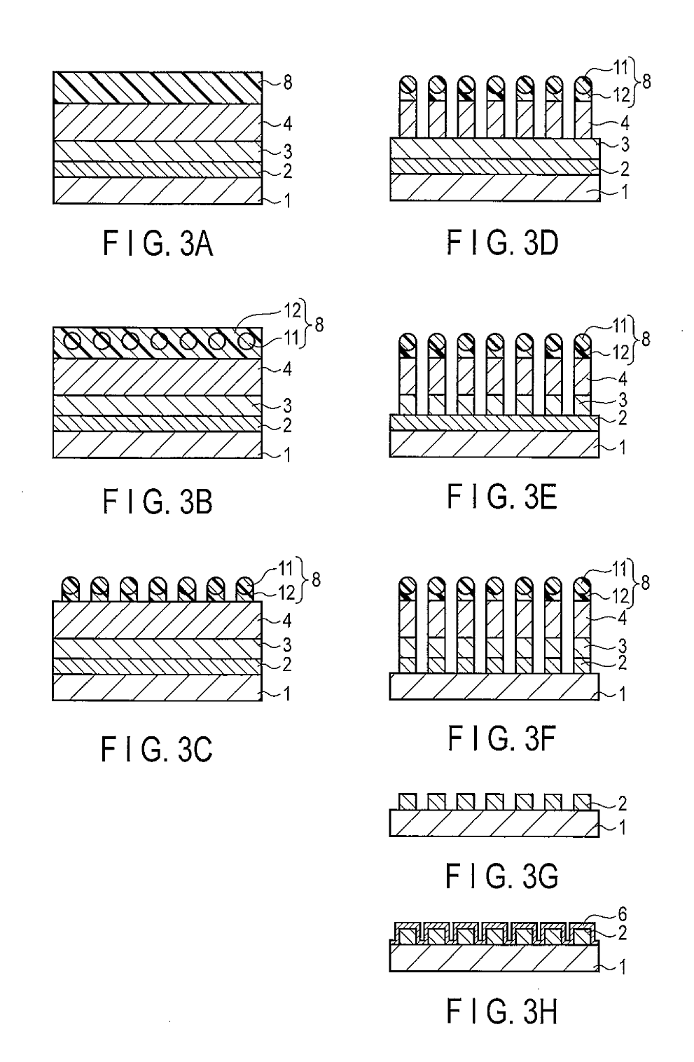

FIGS. 3A, 3B, 3C, 3D, 3E, 3F, 3G, and 3H are views showing an example of a magnetic recording medium manufacturing method using self-organization lithography.

When using a self-organized film, steps shown in FIGS. 3D, 3E, 3F, 3G, and 3H are the same as those shown in FIGS. 10, 10, 1E, 1F, and 1G except that, instead of forming the resist layer 5 on the mask layer 4 as shown in FIG. 1A and transferring three-dimensional patterns by photolithography as shown in FIG. 1B, a self-organized layer 8 made of a block copolymer having two or more types of polymer chains is formed as shown in FIG. 3A, micro phase-separated structures 11 and 12 are formed in the self-organized layer 8 by performing, e.g., thermal annealing as shown in FIG. 3B, and three-dimensional patterns are transferred by selectively removing one type of a polymer phase 12 and using a remaining polymer 11 as a mask as shown in FIG. 3C.

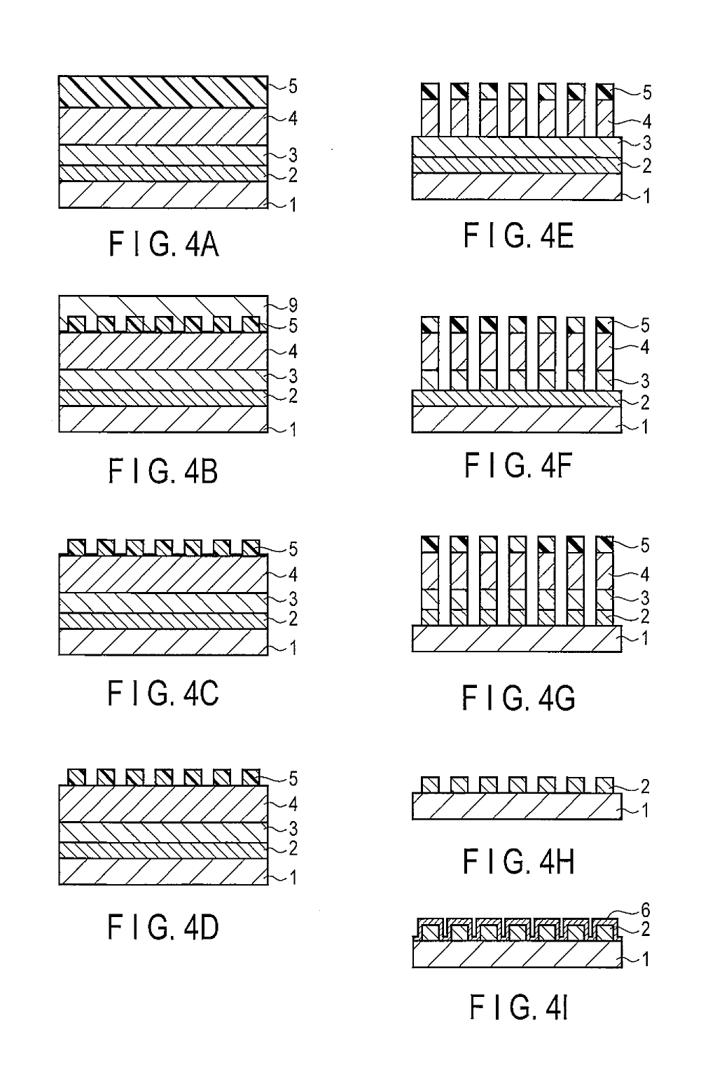

FIGS. 4A, 4B, 4C, 4D, 4E, 4F, 4G, 4H, and 4I are views showing an example of a magnetic recording medium manufacturing method using nanoimprinting.

When using nanoimprinting, steps shown in FIGS. 4E, 4F, 4G, 4H, and 4I are the same as those shown in FIGS. 1C, 1D, 1E, 1F, and 1G except that, instead of transferring three-dimensional patterns by photolithography as shown in FIG. 1B after a resist layer 5 is formed on a mask layer 4 as shown in FIG. 4A in the same manner as in FIG. 1A, three-dimensional patterns are transferred as shown in FIG. 4C by applying a stamper on the resist layer 5 to pressurize it as shown in FIG. 4B, and the resist residue between projecting patterns is removed by, e.g., dry etching as shown in FIG. 4D.

The individual steps used in the embodiment will be explained below.

### Perpendicular Magnetic Recording Layer Formation Step

First, a perpendicular magnetic recording medium is obtained by forming a perpendicular magnetic recording layer on a substrate.

Although the shape of the substrate is not limited at all, the substrate is normally circular and made of a hard material. Examples are a glass substrate, metal-containing substrate, carbon substrate, and ceramics substrate. To improve the pattern in-plane uniformity, the roughness of the substrate surface can be decreased. It is also possible to form a protective film such as an oxide film on the substrate surface as needed. As the glass substrate, it is possible to use amorphous glass such as soda lime glass or aluminosilicate glass, or crystallized glass such as lithium-based glass. Furthermore, a sintered substrate mainly containing alumina, aluminum nitride, or silicon nitride can be used as the ceramics substrate.

A magnetic recording layer including a perpendicular magnetic recording layer mainly containing cobalt is formed on the substrate. A soft under layer (SUL) having a high magnetic permeability can be formed between the substrate and perpendicular magnetic recording layer. The soft under layer refluxes a recording magnetic field from a magnetic head for magnetizing the perpendicular magnetic recording layer, i.e., performs a part of the magnetic head function. The soft under layer can apply a sufficient steep perpendicular magnetic field to the magnetic field recording layer, thereby increasing the recording/reproduction efficiency. A material containing Fe, Ni, or Co can be used as the soft under layer. Among these materials, it is possible to use an amorphous material having none of magnetocrystalline anisotropy, a crystal defect, and a grain boundary, and showing a high soft magnetism. The soft amorphous material can reduce the noise of the recording medium. An example of the soft amorphous material is a Co alloy mainly containing Co and also containing at least one of Zr, Nb, Hf, Ti, and Ta, and it is possible to select, e.g., CoZr, CoZrNb, or CoZrTa.

In addition, a base layer for improving the adhesion of the soft under layer can be formed between the soft under layer and substrate. As the base layer material, it is possible to use, e.g., Ni, Ti, Ta, W, Cr, Pt, and alloys, oxides, and nitrides of these elements. For example, it is possible to use NiTa and NiCr. Note that the base layer can include a plurality of layers.

Furthermore, an interlayer made of a nonmagnetic metal material can be formed between the soft under layer and perpendicular magnetic recording layer. The interlayer has two functions: to interrupt the exchange coupling interaction between the soft under layer and perpendicular magnetic recording layer; and to control the crystallinity of the perpendicular magnetic recording layer. The interlayer material can be selected from Ru, Pt, Pd, W, Ti, Ta, Cr, Si, and alloys, oxides, and nitrides of these elements.

The perpendicular magnetic recording layer mainly contains Co, also contains at least Pt, and can further contain a metal oxide. In addition to Co and Pt, the layer can also contain one or more elements selected from B, Ta, Mo, Cu, Nd, W, Nb, Sm, Tb, and Ru. When these elements are contained, it is possible to promote downsizing of magnetic grains, and improve the crystallinity and alignment, thereby obtaining recording/reproduction characteristics and thermal fluctuation characteristics for a high recording density. Practical examples of the material usable as the perpendicular magnetic recording layer are alloys such as a CoPt-based alloy, a CoCr-based alloy, a CoCrPt-based alloy, CoPtO, CoPtCrO, CoPtSi, CoPtCrSi, CoCrSiO₂, and CoCrPtSiO₂. The thickness of the perpendicular magnetic recording layer can be set to 5 nm or more in order to measure a reproduced output signal with high accuracy, and can be set to 40 nm or less in order to suppress the distortion of the signal intensity. If the thickness is smaller than 5 nm, the reproduced output is extremely low, and the noise component becomes dominant. On the other hand, if the thickness is larger than 40 nm, the reproduced output becomes excessive, and the signal waveform is distorted.

A protective layer can be formed on the perpendicular magnetic recording layer. The protective layer has the effect of preventing corrosion and deterioration of the perpendicular magnetic recording layer, and also has the effect of preventing damage to the medium surface when a magnetic head comes in contact with the recording medium. Examples of the protective layer material are materials containing C, Pd, SiO₂, and ZrO₂. Carbon can be classified into sp²-bonded carbon (graphite) and sp³-bonded carbon (diamond). Sp³-bonded carbon is superior in durability and corrosion resistance, and sp²-bonded carbon is superior in flatness. Carbon is normally deposited by sputtering using a graphite target, and amorphous carbon containing both sp²-bonded carbon and sp³-bonded carbon is deposited. Carbon in which the ratio of sp³-bonded carbon is high is called diamond-like carbon (DLC). DLC is superior in durability, corrosion resistance, and flatness, and usable as the protective layer of the magnetic recording layer.

Furthermore, a lubricating layer can be formed on the protective layer. Examples of a lubricant used in the lubricating layer are perfluoropolyether, alcohol fluoride, and fluorinated carboxylic acid. By the process described above, the perpendicular magnetic recording medium is formed on the substrate.

### Release Layer Formation Step

Subsequently, a release layer is formed on the magnetic recording layer. The release layer is removed by dry etching and wet etching, and finally achieves a function of removing the mask material from the surface of the magnetic recording layer. As described previously, the release layer need only be soluble in one of at least two types of solvents of a phase-separated release solution, and can be selected by taking the type of solvent into consideration.

The release layer can be selected from the group consisting of various inorganic materials or polymeric materials. The inorganic materials usable as the release layer can be selected from C and metals such as Mo, W, Zn, Co, Ge, Al, Cu, Au, Ni, and Cr. These inorganic materials can be removed by using an acid solution or alkali solution.

Examples of the polymeric materials usable as the release layer are a novolak resin as a versatile resist material, polystyrene, polymethylmethacrylate, methylstyrene, polyethyleneterephthalate, polyhydroxystyrene, polyacrylic acid, polyarylic acid, polyamic acid, polyethylenesulfonic acid, polystyrenesulfonic acid, maleic acid, polyamide, polyacrylamide, polyamidoamine, polymethylacrylamide, polyvinylalcohol, polyvinylacetal, polyvinylpyrrolidone, polyvinylamine, polyethyleneglycol, polyethyleneimine, polyethyleneoxide, and polymethylcellulose. These resist materials can be removed by using an organic solvent or water. Note that these materials may also be composite materials containing a metal in order to increase the etching resistance.

The release layer made of the metal material can be formed by physical vapor deposition (PVD) such as vacuum deposition, electron beam deposition, molecular beam deposition, ion beam deposition, ion plating, or sputtering, or chemical vapor deposition (CVD) using heat, light, or plasma. The release layer made of the polymeric material or the like can be formed by applying a precursor solution prepared by dissolving the polymeric material in a solvent, by using, e.g., spin coating, spray coating, spin casting, dip coating, or an inkjet method.

The thickness of the release layer can appropriately be adjusted by changing parameters such as the process gas pressure, gas flow rate, substrate temperature, input power, ultimate vacuum degree, chamber ambient, and deposition time in PVD and CVD. When using the polymeric material, the thickness can appropriately be changed by parameters such as the concentration of a polymeric release layer precursor, and the substrate rotational speed and coating time set during deposition. When transferring three-dimensional patterns, the thickness of the release layer can be adjusted in accordance with the pattern dimensions, so that removal is possible and the three-dimensional structure does not collapse.

### Mask Layer Formation Step

A first mask layer for transferring three-dimensional patterns is formed on the release layer.

Since the mask layer functions as a main mask when processing the magnetic recording layer, a material capable of maintaining the etching selectivity can be used. Practical material examples are Al, Si, Ti, V, Cr, Mn, Co, Ni, Cu, Zn, Ga, Ge, Zr, Nb, Mo, Ru, Pd, Ag, Hf, Ta, W, Pt, and Au. It is also possible to apply materials made of compounds or alloys of these elements to the mask layer. In this case, it is only necessary to properly determine a mask material capable of securing the etching selectivity to the three-dimensional patterns of a resist layer to be formed on the mask layer, and the film thickness of the mask material.

Like the release layer, the mask layer can be formed by physical vapor deposition or chemical vapor deposition.

The thickness of the mask layer can be determined by taking account of the etching selectivities to the release layer and magnetic recording layer, and the three-dimensional pattern dimensions. When depositing the mask layer, its thickness can be adjusted by changing parameters such as the process gas pressure, gas flow rate, substrate temperature, input power, ultimate vacuum degree, chamber ambient, and deposition time.

The transfer uniformity of three-dimensional patterns to be formed on the mask layer largely depends on the surface roughness of the mask layer. Since the dependence on the surface roughness of the mask layer is large, therefore, the roughness can be reduced by using an amorphous material rather than a crystalline material.

Furthermore, the mask layer can have a multilayered structure including an etchable first layer and a transfer layer made of a material different from the first layer. In this case, it is favorable to optimally select metal materials corresponding to an etching solution or etching gas. When combining materials by assuming dry etching, examples are C/Si, Si/Al, Si/Ni, Si/Cu, Si/Mo, Si/MoSi₂, Si/Ta, Si/Cr, Si/W, Si/Ti, Si/Ru, and Si/Hf from the substrate side, and Si can be replaced with SiO₂, Si₃N₄, SiC, or the like. It is also possible to select multilayered structures such as Al/Ni, Al/Ti, Al/TiO₂, Al/TiN, Cr/Al₂O₃, Cr/Ni, Cr/MoSi₂, Cr/W, GaN/Ni, GaN/NiTa, GaN/NiV, Ta/Ni, Ta/Cu, Ta/Al, and Ta/Cr.

The combination of the mask materials and the stacking order are not limited to those enumerated above, and can properly be selected from the viewpoints of the pattern dimensions and etching selectivity. Since projection patterning by wet etching is also possible as well as dry etching, each mask material can be selected by taking this into account.

### Resist Layer Formation Step

Then, a resist layer for forming three-dimensional patterns is formed on the mask layer.

To form fine three-dimensional patterns on the resist layer, it is possible to apply an ultraviolet/electron beam exposure resist such as a novolak resin, a nanoimprinting resist that is cured by heat or ultraviolet irradiation, or a polymeric self-organized film.

The resist layer to be used to perform exposure or nanoimprinting can be formed by applying a precursor solution in the same manner as that for the above-described release layer. In this case, the thickness of the resist layer can be determined by taking account of the pattern pitch and the etching selectivity to the lower mask layer. Also, the resist layer need not be a single layer, and may also have a multilayered structure including resist layers different in, e.g., sensitivity. The type of resist material is not at all limited, and it is possible to use various resist materials such as a main chain scission resist, chemical amplification resist, and crosslinking resist.

It is also possible to form a self-organized film for three-dimensional pattern formation on the mask layer, and transfer the film to three-dimensional patterns. The self-organized film is typically a diblock copolymer having at least two different polymer chains. This diblock copolymer has a basic structure in which the ends of polymers having different chemical characteristics are covalently bonded like (block A)-(block B). The self-organized film is not limited to the diblock copolymer, and can also be a triblock copolymer or random copolymer.

Examples of the material forming the polymer block are polyethylene, polystyrene, polyisoprene, polybutadiene, polypropyrene, polydimethylsiloxane, polyvinylpyridine, polymethylmethacrylate, polybutylacrylate, polybutylmethacrylate, polydimethylacrylamide, polyethyleneoxide, polypropyreneoxide, polyacrylic acid, polyethylacrylic acid, polypropylacrylic acid, polymethacrylic acid, polylactide, polyvinylcarbazole, polyethyleneglycol, polycaprolactone, polyvinylidene fluoride, and polyacrylamide. The block copolymer can be formed by using two or more different types of polymers among these polymers.

The self-organized film using the block copolymer can be deposited on the metal mask layer by using spin coating or the like. In this case, a solvent by which polymers forming individual phases are compatible to each other is selected, and a solution prepared by dissolving the polymers in the solvent is used as a coating solution.

Practical examples selectable as the solvent are toluene, xylene, hexane, heptane, octane, ethyleneglycol monoethylether, ethyleneglycol monomethylether, ethyleneglycol monomethyletheracetate, propyleneglycol monomethyletheracetate, ethyleneglycol trimethylether, ethyl lactate, ethyl pyruvate, cyclohexanone, tetrahydrofuran, anisole, and diethyleneglycol triethylether.

The film thickness of the self-organized film can be changed by using the concentration of the coating solution when using any of these solvents, or various parameters to be set when performing deposition.

When energy such as heat is applied to the self-organized film, the polymers cause phase separation and form a micro phase-separated structure inside the film. The micro phase-separated structure looks different in accordance with, e.g., the molecular weights of polymers forming the self-organized film. For example, island-like dots or cylindrical structures of polymer B are formed in a sea-like (matrix) pattern of polymer A in a diblock copolymer. It is also possible to form a lamella structure in which polymers A and B are stacked, or a sphere structure in which the sea and island patterns are switched. The three-dimensional structure of the self-organized film can be formed by selectively removing one polymer phase in this pattern.

Energy is externally given when forming the micro phase-separated structure of the self-organized film. Energy can be given by, e.g., annealing using heat, or so-called solvent annealing by which a sample is exposed to a solvent ambient. When performing thermal annealing, the temperature can properly be set so as not to deteriorate the arrangement accuracy of the self-organized film, and so as not to decompose the polymeric layer that can be used as, e.g., the release layer.

Note that the upper portion of the mask layer can chemically be modified in order to improve the arrangement accuracy of the self-organized patterns. More specifically, the arrangement of the block copolymer can be improved by modifying, on the mask surface, any polymer phase forming the block copolymer. In this case, surface modification on a molecular level can be performed by polymer coating, annealing, and rinsing. Patterns having high in-plane uniformity can be obtained by coating this mask surface with the above-described block copolymer solution.

If it is difficult to transfer the three-dimensional patterns to the resist layer, a pattern transfer layer can be inserted between the mask layer and resist layer. In this case, it is possible to select a material capable of securing the etching selectivity between the resist layer and mask layer.

### Resist Layer Patterning Step

Three-dimensional patterns are formed in the resist layer by etching.

First, exposure using an energy line can be performed to transfer the three-dimensional patterns to the resist layer. As the exposure method, it is possible to apply, e.g., ultraviolet exposure or electron beam exposure by KrF or ArF, charged-particle beam exposure, and X-ray exposure. In addition to irradiation using an exposure mask, it is also possible to perform interference exposure, reduced projection exposure, and direct exposure.

First, an example of the formation of fine patterns by electron beam exposure will be explained. Examples of an electron beam lithography apparatus are an x-y lithography apparatus including stage moving mechanisms in biaxial directions perpendicular to an electron beam irradiation direction, and an x-θ lithography apparatus including a rotating mechanism in addition to a uniaxial moving mechanism. When using the x-y lithography apparatus, the stage can continuously be moved so as not to decrease the accuracy of connection between writing fields. When writing concentric patterns, the x-θ lithography apparatus that continuously rotates the stage can be used.

Also, when forming concentric patterns, deflection can be added to an electron beam in addition to the stage driving system. In this case, an information processor called a signal source is used in order to independently control deflection signals corresponding to writing patterns. The signal source can independently control the deflection pitch and deflection sensitivity of the electron beam, and the feed amount of the writing stage. By thus transmitting the deflection signal to the electron beam for each rotation, writing patterns can be formed into a concentric shape.

Then, the deposited resist film is patterned by exposing and developing the resist film. As an organic developer for the resist film, it is possible to use ester-based solvents such as methyl acetate, ethyl acetate, butyl acetate, amyl acetate, hexyl acetate, and octyl acetate, ketone-based solvents such as methylethylketone, methylisobutylketone, and propyleneglycol monoethylacetate, aromatic solvents such as anisole, xylene, toluene, and tetralin, and alcohol-based solvents such as ethanol, methanol, and isopropylalcohol. As an alkali developer, it is possible to use, e.g., tetramethylammoniumhydroxide and tetrapropylammoniumhydroxide.

Subsequently, the developer on the resist film is removed by wet rinsing. The rinsing solution can be compatible with the developer, and a typical example is isopropylalcohol. In development and rinsing, desired pattern dimensions are obtained by adjusting the developing time in addition to parameters pertaining to the solution, e.g., the temperature, viscosity, and mixing ratio.

Note that a phase-separated release solution using separated solvents is also applicable to the development step. In this case, the exposed resist patterns need only be soluble in one solvent. Since dust after development stays in one solvent, it is possible to suppress the redeposition of dust after development, and achieve both the flatness and uniformity of patterns. When manufacturing a nanoimprinting stamper (to be described later) from a master template, for example, a stamper having little dust can be obtained by using the phase-separated release solution as described above when developing resist patterns on the master template.

Desired resist three-dimensional patterns are obtained by drying the rinsing solution on the resist film. As the drying method, it is possible to apply spin drying or supercritical drying, in addition to a method of directly blowing an inert gas such as N₂ against the sample, or heat drying by which the rinsing solution is volatilized by heating the substrate to a temperature higher than the boiling point of the rinsing solution. The three-dimensional patterns of the resist film can be obtained by electron beam exposure as described above.

Also, as a method of transferring the three-dimensional patterns to the resist layer, it is possible to form a self-organized layer as the resist layer, and form three-dimensional patterns by etching.

As shown in the drawings, these manufacturing steps are the same as those shown in FIGS. 1A, 1B, 1C, 1D, 1E, 1F, and 1G, except that a step of forming a self-organized layer having at least two different types of polymer chains as one type of a resist layer on the mask layer is performed, instead of the step of forming the resist layer on the mask layer, and a step of causing phase separation in the self-organized layer and selectively removing one polymer layer is performed, instead of the step of forming three-dimensional patterns in the resist layer.

The three-dimensional patterns are obtained by selectively removing a phase from a block copolymer. For example, in the diblock copolymer made of a polystyrene-b-polydimethylsiloxane system, patterns of island-like polydimethylsiloxane are formed in sea-like polystyrene by properly setting the molecular weights. Dot-like, three-dimensional patterns of polystyrene-b-polydimethylsiloxane are obtained by selectively removing one polymer layer, e.g., the sea-like polystyrene by etching the diblock copolymer.

When forming the three-dimensional structure of the self-organized layer by etching, it is possible to apply wet etching by which a sample is dipped in a liquid chemical, and dry etching using a chemical reaction of an active species. To precisely perform patterning in the thickness direction with respect to the width of fine patterns, it is possible to apply dry etching capable of suppressing etching in the widthwise direction.

In dry etching of a polymer phase, patterning can be performed while maintaining the etching selectivity by appropriately selecting an active gas species. Generally, a material containing large amounts of C and H such as a benzene ring has a high etching resistance and hence can be used as a three-dimensional structure processing mask. The etching selectivity can be increased when using a material such as a block copolymer formed by appropriately combining polymers having different compositions, so the above-mentioned, three-dimensional patterns can be formed. When using polystyrene-b-polydimethylsiloxane, for example, it is readily possible to remove polydimethylsiloxane by using a fluorine-based gas such as CF₄, and remove polystyrene by using O₂ gas. Accordingly, the etching selectivity can be secured between them.

If it is difficult to directly transfer the self-organized patterns to the lower mask layer, a transfer layer can be formed between the self-organized film and metal mask layer. For example, a mask material by which an etching gas capable of removing one layer of the block copolymer is usable as this transfer layer. When using polystyrene-b-polydimethylsiloxane, for example, polystyrene can be removed by O₂ etching, so it is possible to simultaneously etch the polymer and transfer layer by using only O₂ if a carbon film is used as the transfer layer. When the sea-like polymer is polydimethylsiloxane, etching is similarly possible by using CF₄ gas and Si as the transfer layer. By the process described above, the phase-separated patterns of the self-organized film can be processed into a three-dimensional shape.

If it is difficult to ensure the etching selectivity to the self-organized film, a pattern transfer layer can further be formed on the mask layer. It is possible to select a material by which the self-organized layer as an upper layer can be etched, and apply the material to the transfer layer in this case as well.

Furthermore, three-dimensional pattern formation by nanoimprinting lithography is also usable as the method of transferring the three-dimensional patterns to the resist layer.

Nanoimprinting is a method of transferring fine three-dimensional patterns formed on the surface of a stamper by pressing the stamper against a transfer resist layer. This method can transfer resist patterns over a broad range at once, when compared to step-and-repeat ultraviolet exposure and electron beam exposure. Accordingly, the throughput can largely be improved by short-time processing.

The nanoimprinting stamper can be obtained from a substrate having fine three-dimensional patterns formed by lithography or the like, i.e., from a so-called master template. In many cases, the stamper is manufactured by electroforming for the fine patterns of the master template. As the substrate of the master template, it is possible to use Si, SiO₂, SiC, SiOC, Si₃N₄, or a semiconductor substrate in which an impurity such as B, Ga, In, or P is doped. In addition, a substrate made of a conductive material can be used. Also, the three-dimensional shape of the substrate is not at all limited, and it is possible to use a circular, rectangular, or doughnut-like substrate.

Three-dimensional resist patterns are formed on the master template by forming the resist layer, performing lithography by electron beam exposure, and performing development and rinsing as described above. The resist three-dimensional patterns are then transferred to the mask layer or substrate by etching, thereby obtaining the master template having the three-dimensional patterns of the mask layer or substrate.

A stamper is manufactured by electroforming the three-dimensional patterns of the master template.

Although various materials can be used as a plating metal, a method of manufacturing a Ni stamper will be explained as an example. First, to give conductivity to the three-dimensional patterns of the master template, a thin Ni film is deposited on the surface of the three-dimensional patterns. If defective conduction occurs during electroforming, plating growth is interrupted, and pattern loss occurs. Therefore, the thin Ni film must evenly be deposited on the upper surface and side surfaces of the three-dimensional patterns. Note that this electroforming may also be performed by electroplating or electroless plating, and NiP or NiB can be formed.

Subsequently, the master template is dipped in a Ni sulfamate bath, and an electric current is supplied to the bath, thereby performing electroforming. The film thickness after plating, i.e., the stamper thickness can be adjusted by changing, e.g., the supplied current value and plating time, in addition to the hydrogen ion concentration, temperature, and viscosity of the plating bath.

The stamper thus obtained is released from the substrate surface. If the resist layer remains on the three-dimensional surface of the released stamper, the three-dimensional patterns can be exposed by removing the residue by etching. Finally, a nanoimprinting stamper is obtained by processing the stamper into a desired shape such as a circle or rectangle.

The three-dimensional patterns are transferred to the resist layer by using the obtained stamper. In this case, a duplicated stamper can be electroformed by using the stamper in place of the master template. Examples are a method of obtaining a Ni stamper from a Ni stamper, and a method of obtaining a resin stamper from a Ni stamper. The method of manufacturing a resin stamper will be explained as an example.

A resin stamper is manufactured by injection molding. First, the Ni stamper is loaded in an injection molding apparatus, and injection molding is performed by supplying a resin solution material to the three-dimensional patterns of the stamper. It is possible to apply, e.g., a cycloolefin polymer, polycarbonate, or polymethylmethacrylate as the resin solution material, and select a material having high removability to the imprinting resist. After molding, a resin stamper having a three-dimensional structure is obtained by releasing the resin stamper from the Ni stamper.

By using this resin stamper, the three-dimensional patterns are transferred to the resist layer on the metal mask layer. As the resist, it is possible to use a resist material such as a thermosetting resin or photosetting resin. For example, isobornyl acrylate, allyl methacrylate, or dipropyleneglycol diacrylate can be applied.

A sample including the magnetic recording layer and metal mask layer as described above is coated with any of these resist materials, thereby forming a resist layer. Then, the resin stamper having the three-dimensional patterns is imprinted on the resist layer. When the resist stamper is pressed against the resist during imprinting, the resist fluidizes to form three-dimensional patterns. The resist layer forming the three-dimensional patterns is cured by giving energy such as ultraviolet radiation to the resist layer, and the resin stamper is then released, thereby obtaining the three-dimensional patterns of the resist layer. To facilitate releasing the resin stamper, release processing using a silane coupling agent or the like can be performed on the resin stamper surface beforehand.

Since the resist material remains as a residue in the recesses of the resist layer, this residue is removed by etching. A polymer-based resist material generally has a low etching resistance to an O₂ etchant, so the residue is readily removable by O₂ etching. When an inorganic material is contained, an etchant can properly be changed so that the resist patterns remain. The three-dimensional patterns can be formed on the magnetic recording medium by nanoimprinting as described above.

### Mask Layer Patterning Step

Subsequently, the three-dimensional patterns of the resist layer are transferred to the mask layer.

When processing the mask layer, it is possible to implement various layer arrangements and processing methods by combining a mask layer material and etching gas.

In the same way as for the above-described resist layer, dry etching is applicable when performing micropatterning, such that etching in the thickness direction of the three-dimensional patterns is significant with respect to etching in the widthwise direction. Plasma usable in dry etching can be generated by various methods such as capacitive coupling, inductive coupling, electron cyclotron resonance, and multi-frequency superposition coupling. Also, to adjust the pattern dimensions of the three-dimensional patterns, it is possible to set parameters such as the process gas pressure, gas flow rate, plasma input power, substrate temperature, chamber ambient, and ultimate vacuum degree.

When stacking metal materials in order to increase the etching selectivity, an etching gas can properly be selected. Examples of the etching gas are fluorine-based gases such as CF₄, C₂F₆, C₃F₆, C₃F₈, C₅F₈, C₄F₈, ClF₃, CCl₃F₅, C₂ClF₅, CCBrF₃, CHF₃, NF₃, and CH₂F₂, and chlorine-based gases such as Cl₂, BCl₃, CCl₄, and SiCl₄. Other various gases such as H₂, N₂, Br₂, HBr, NH₃, CO, C₂H₄, He, Ne, Ar, Kr, and Xe can also be applied. It is also possible to use a gas mixture obtained by mixing two or more types of these gases in order to adjust the etching rate or etching selectivity. Note that patterning can be performed by wet etching if it is possible to secure the etching selectivity and suppress etching in the widthwise direction. Similarly, physical etching such as ion milling can be performed.

The mask layer can have various arrangements in accordance with combinations with the resist layer. Examples are C/Si, Ta/Al, Al/Ni, and Si/Cr from the substrate side.

### Release Layer Patterning Step

Subsequently, the three-dimensional patterns are transferred to the release layer.

The three-dimensional patterns can be transferred by etching in the same manner as for the mask layer. If wet etching is performed, however, the release layer dissolves, and the metal mask layer may collapse. Accordingly, pattern transfer can be performed by dry etching.

When performing dry etching by using a chemically active gas, it is important for the sake of the process to reduce modification on the surface of the polymeric release layer. If etching modifies the surface, the removability to plasma or an etching solution decreases. For example, if dry etching using a fluorine-based gas is performed in the same manner as when removing a Si mask, the surface of the polymeric release layer is modified by the etching gas and becomes sparingly soluble in an organic solvent and water. This significantly deteriorates the removability of the mask. In this case, it is possible to properly select an etching gas, e.g., avoid the deterioration of the removability by performing dry etching using O₂ gas.

When patterning the release layer and magnetic recording layer, these layers can separately be etched, but they can also be processed at once by a method such as ion milling.

### Magnetic Recording Layer Patterning Step

Then, the three-dimensional patterns are transferred to the magnetic recording layer below the release layer.

To form magnetically isolated dots, a typical method is to form three-dimensional patterns by applying the above-mentioned reactive ion etching or milling. In this case, patterning can be performed by a method of applying CO or NH₃ as an etching gas, or by ion milling using an inert gas such as Ar.

When transferring the three-dimensional structure to the magnetic recording layer by ion milling, it is necessary to suppress a byproduct that scatters toward the mask sidewalls by etching or milling, i.e., a so-called redeposition component. Since this redeposition component adheres around the projecting patterns, the projecting patterns increase the dimensions and fill the grooves. To obtain divided perpendicular magnetic recording layer patterns, therefore, it is important to reduce the redeposition component as soon as possible. Also, if the redeposition component produced when the perpendicular magnetic recording layer below the release layer is etched covers the side surfaces of the release layer, the release layer is not exposed to the release solution any longer, and the removability deteriorates. Accordingly, the redeposition component must be reduced.

When performing ion milling to the perpendicular magnetic recording layer, the redeposition component on the sidewalls can be reduced by changing the ion incident angle. Although an optimal incident angle changes in accordance with the mask height, redeposition can be suppressed within the range of 20° to 70°. Also, the incident angle can appropriately be changed during milling.

### Removing Step

Subsequently, the mask patterns on the magnetic recording layer are removed together with the release layer, thereby obtaining the magnetic recording layer having the three-dimensional patterns.

As described above, the release layer is made of a metal or polymeric material and hence can be removed by wet removal using an acid, alkali, or organic solvent capable of dissolving the metal or polymeric material.

Although various solvents are compatible with each other or sparingly soluble in each other in accordance with combinations, the embodiment uses separated solvents sparingly soluble in each other.

A solubility parameter is an index indicating the easiness of dissolution or separation of each solvent. The solubility parameter is a value unique to each solvent; the larger the difference between the values, the higher the easiness of separation between the solvents. For example, hexane (7.3) or xylene (8.8) having a small solubility parameter easily separates from water (23.4) having a large solubility parameter. Examples of a combination of solvents that separate into two layers are water-anisole, water-cyclohexane, water-toluene, and water-amyl acetate. Any of these combinations can be used as a release solution.

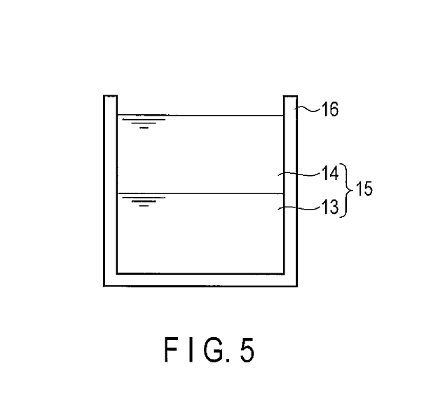

FIG. 5 is an exemplary view showing an example of the phase-separated release solution used in the embodiment.

As shown in FIG. 5, a phase-separated release solution 15 that is contained in a vessel 16 and separates into two phases separates into an upper phase 14 and lower phase 13 in accordance with the specific gravities. For the sake of convenience, a case in which the lower phase 13 is a first solvent capable of dissolving the release layer and the upper phase 14 is a second solvent will be explained. As described above, solvents can be separated when the difference between the solubility parameters is large, and water can be used as one solvent. When using water and anisole as an example, the solution separates into water as the first solvent and anisole as the second solvent because the specific gravity of anisole is smaller than that of water.

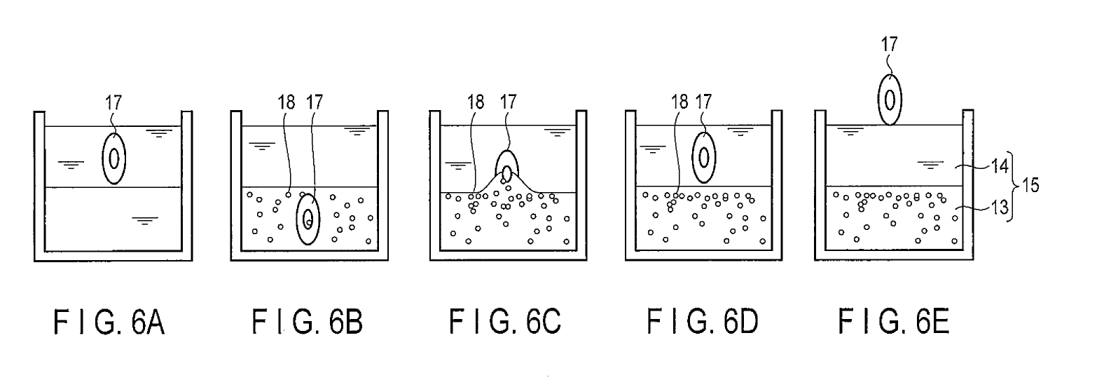

FIGS. 6A, 6B, 6C, 6D, and 6E are exemplary views showing an example of the removing step according to the embodiment.

A case in which a water-soluble resist is used as the release layer will be explained.

When a sample 17 is dipped in the phase-separated release solution 15 as shown in FIG. 6A, the second solvent as the upper phase 14 does not dissolve the resist, but water dissolves the water-soluble resist when it is dipped in the first solvent as shown in FIG. 6B. Also, as shown in FIG. 6C, when the sample 17 is pulled up to the second solvent, the first solvent is pulled up together with the sample 17, but returns to the lower phase 13 because the first solvent is not compatible with the hydrophobic second solvent.

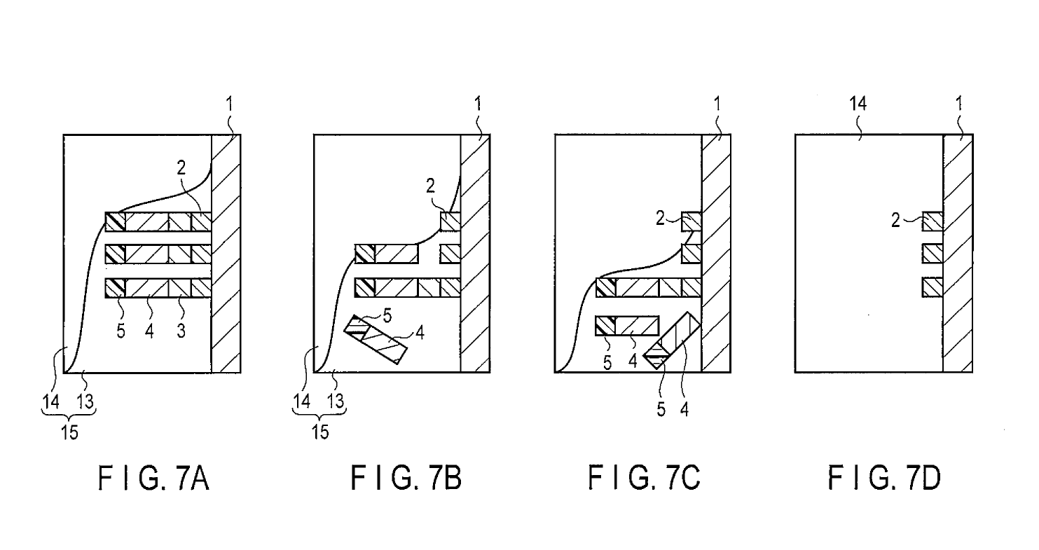

FIGS. 7A, 7B, 7C, and 7D are views showing the way the sample 17 is pulled up to the second solvent.

When the sample 17 is dipped in the lower phase 13 and pulled up to the second solvent as the upper phase 14 as shown in FIG. 7A, the first solvent returning to the lower phase 13 dissolves the release layer 3 on the sample 17 as shown in FIG. 75, and returns to the lower phase 13 together with the mask layer 4 and resist layer 5 formed on the release layer 3 as shown in FIG. 7C. This achieves the effect of physically removing the mask layer from the surface of the sample 17. Dust particles 18 such as the removed mask layer stay in only the lower phase 13 together with the hydrophilic first solvent, and are not liberated in the hydrophobic second solvent as shown in FIGS. 6D and 7D. When the sample 17 is pulled up, therefore, the redeposition of the dust particles 18 cannot occur in the second solvent. Consequently, a highly flat medium is obtained as shown in FIG. 6E. Also, when the magnetic recording layer is sparingly soluble in the separated solvents, elution from the recording layer is extremely little, so deterioration of the magnetic characteristics can be suppressed. In addition, when mixing water in an organic solvent, the use amount can be reduced compared to a conventional example using an organic solvent alone. This leads to a cost reduction.

The medium can pass through the solution interface a plurality of number of times, and this cleans the medium surface.

In the above explanation, it is possible to dissolve the release layer by the first solvent, and clean the sample surface by the second solvent. However, the upper and lower solvents may also be switched.

That is, it is also possible to dissolve the release layer by the first solvent in the upper phase, and clean the surface by the second solvent in the lower phase. Since, however, the dust particles are liberated in the second solvent in the upper phase, the second solvent must be drained before the sample is pulled up.

The first solvent is not limited to water, and may also be an aqueous solution that dissolves the release layer and separates from the second solvent. A dehydrating agent can be added if a solvent contains water and accelerates dissolution. Practical examples of the dehydrating agent are anhydrous sodium sulfate and anhydrous magnesium sulfate. When a solution to which the dehydrating agent is added is filtered, the filtered solution can be used as a clean solvent containing extremely little water.

If deposition that may produce dust particles occurs in the separated solvent, the solvent can be filtered.

Also, the solvents to be separated are not limited to two types, and multiple types of solvents are applicable.

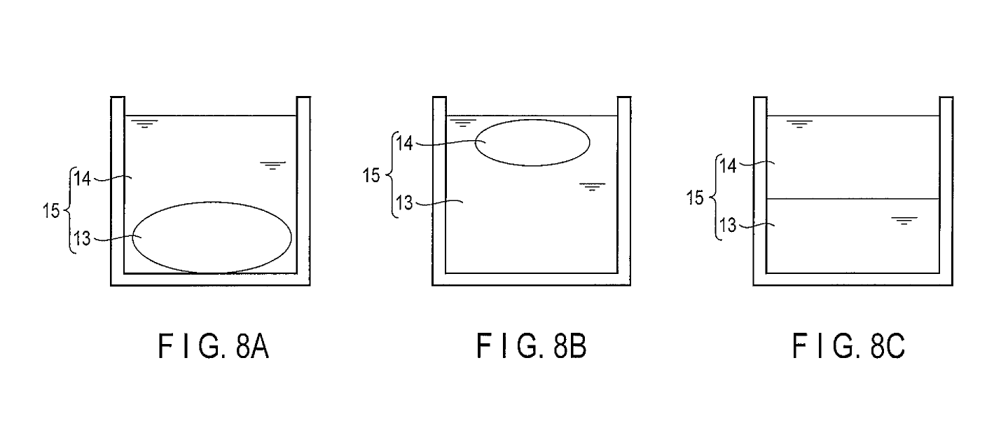

FIGS. 8A, 8B, and 8C are exemplary views showing an example of the phase-separated state of the release solution.

The two types of solvents different in polarity in the release solution used in the embodiment change the way of separation in accordance with the surface properties of the vessel. For example, as shown in FIGS. 8A and 8B, the first solvent such as water becomes close to a sphere on a hydrophobic surface such as PTFE. As shown in FIG. 8C, it is also possible to form a separation interface perpendicular to the direction in which a sample is pulled up.

### Protective Layer Formation Step

Finally, a carbon-based protective layer and a fluorine-based lubricating film (not shown) are deposited on the magnetic recording layer patterns having the three-dimensional structure, thereby obtaining a magnetic recording medium having the three-dimensional patterns.

As the carbon protective layer, a DLC film containing a large amount of sp³-bonded carbon can be used. Also, the film thickness of the protective layer can be set to 2 nm or more in order to maintain the coverage, and 10 nm or less in order to maintain the signal S/N. Furthermore, perfluoropolyether, alcohol fluoride, or fluorinated carboxylic acid can be used as a lubricant.

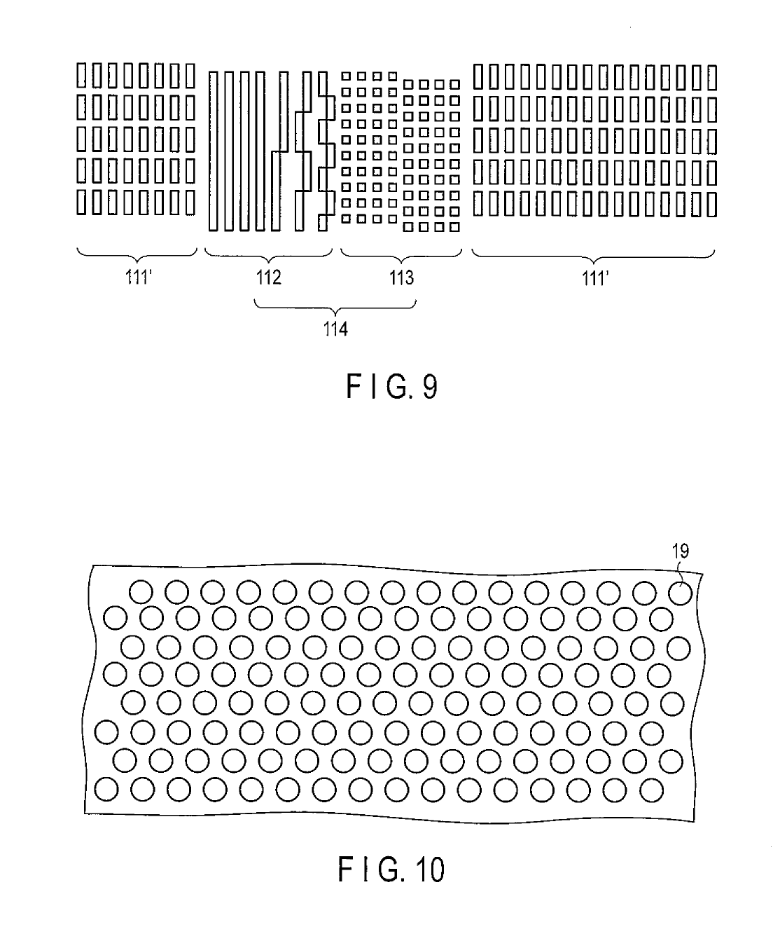

FIG. 9 is a view showing examples of recording bit patterns in the circumferential direction of the magnetic recording medium.

As shown in FIG. 9, the projecting patterns of the magnetic recording layer are roughly classified into a recording bit area 111′ for recording data corresponding to 1 and 0 of digital signals, and a so-called servo area 114 including preamble address patterns 112 serving as a magnetic head positioning signal, and burst patterns 113. These patterns can be formed as in-plane patterns. Note that the patterns in the servo area shown in FIG. 9 need not have rectangular shapes. For example, all the servo patterns may also be replaced with dot-like patterns.

Furthermore, as shown in FIG. 10, not only the servo area but also the data area can entirely be formed by dot patterns 19. One-bit information can be formed by one magnetic dot or a plurality of magnetic dots.

### Cleaning Apparatus Usable in Removing Step

A cleaning apparatus for implementing the removing method as described above can be manufactured.

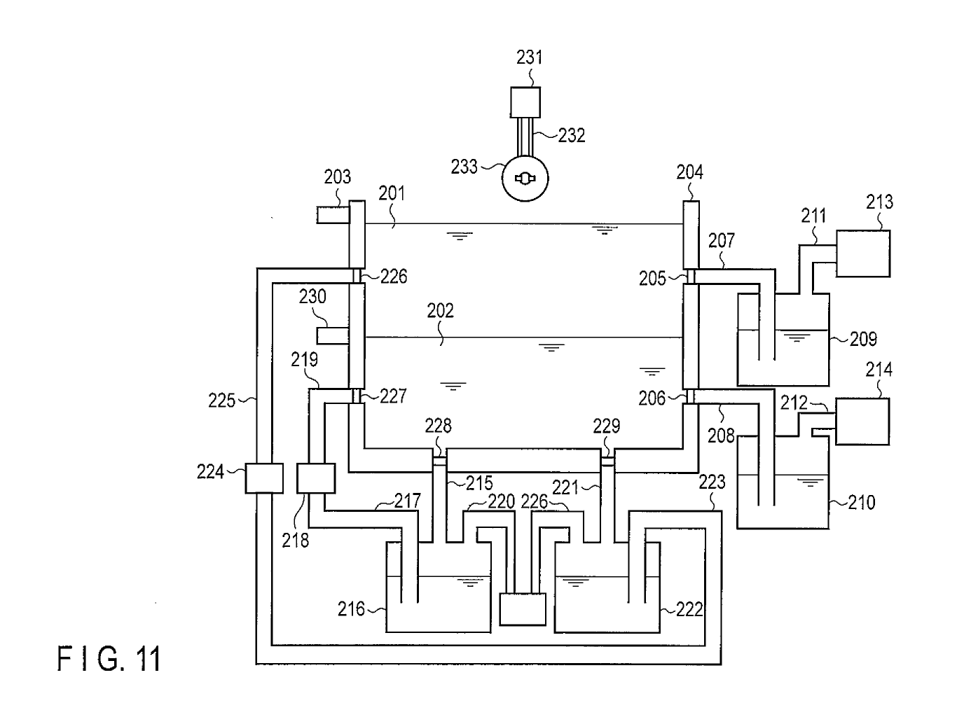

FIG. 11 shows an example of the arrangement of a cleaning apparatus applicable to the embodiment.

This apparatus has a solution supply system including solution supply valves 206 and 205 for first and second solvents 202 and 201, solution supply pipes 208 and 207 for the first and second solvents, storage vessels 210 and 209 for the first and second solvents, pressurizing pipes 212 and 211 for the first and second solvents, and pressuring units 214 and 213 for the first and second solvents. Also, the apparatus includes waste solution valves 228 and 229 and waste solution pipes 215 and 221 for the first and second solvents, and drains the solutions from a main body vessel by using these valves and pipes. Furthermore, the apparatus includes waste solution vessels 216 and 222 for first and second waste solutions, solution supply pipes 217 and 223 for the first and second waste solutions, and filter units 218 and 224 for the first and second waste solutions, and supplies the waste solutions by using these components. In addition, the apparatus has a waste solution system that circulates the waste solutions to the main body through solution supply pipes 219 and 225 and solution supply valves 226 and 227 for the first and second waste solutions. The waste solutions are supplied by using pressurizing units independent of the main body.

A main body vessel 204 includes a level sensor 203 capable of monitoring the level of the solvent. This sensor includes two kinds of sensors: one is a sensor for preventing the solvent from being covered with water, and the other is a sensor for measuring the separation interface of the solvents.

Based on a vessel capable of containing the release solution, the solution supply valves 206 and 205 for the first and second solvents are respectively connected to the solution supply pipes 208 and 207. These solution supply pipes are connected to the solvent storage vessels 210 and 209, and new solvents can be added from these vessels. The solvents are added by using the pressurizing units 214 and 213 connected to the storage vessels 210 and 209. These units are formed by an electronic control system and gas pressure supply system (neither is shown), and pressurize the solvents by supplying an inert gas such as N₂ from the pressurizing pipes, thereby supplying the solvents to the main body vessel through the solution supply pipes 208 and 207. The solution supply valves of the main body vessel are electronically or manually opened and closed, thereby adding the solvents to the main body vessel. The solvent storage vessels 210 and 209 each have a safety valve, and can return the internal pressure of the storage vessel to the atmospheric pressure.

When draining the solvents from the main body vessel 204, the solvents are drained through the first and second waste solution valves 228 and 229 and waste solution pipes 215 and 221 formed in the bottom surface of the main body vessel. The waste solutions are temporarily stored in the first and second waste solution vessels 216 and 222 formed independently of each other, and supplied to the waste solution pipes 217 and 223 by the same method as the pressurization described above. The filter units 218 and 224 are connected to the waste solution pipes 217 and 223, and filter dust particles in the waste solutions. Note that the filter units 218 and 224 filter solutions, so a filter having high affinity to each solvent can be used. Also, the filter pore size of the filter rear stage can be made smaller than that of the filter front stage. This makes it possible to more efficiently collect dust particles.

The filtered waste solutions supplied to the filter rear stage return to the main body vessel via the solution supply valves 226 and 227 connected to the pipes. Therefore, the purified waste solutions can be circulated and reused as the release solvents. Note that instead of individually collecting the first and second waste solutions, the waste solutions in the main body vessel may temporarily be stored in the storage vessels and then separated from each other. It is also possible to circulate only one waste solution.

The main body vessel has a sensor for measuring the level. This sensor is connected to an electronic control system (not shown), and achieves the function of measuring the total level of the solvents and the level of the separation interface. Although the type of sensor is not particularly limited, an optical sensor that allows relatively easy detection and handling can be used.

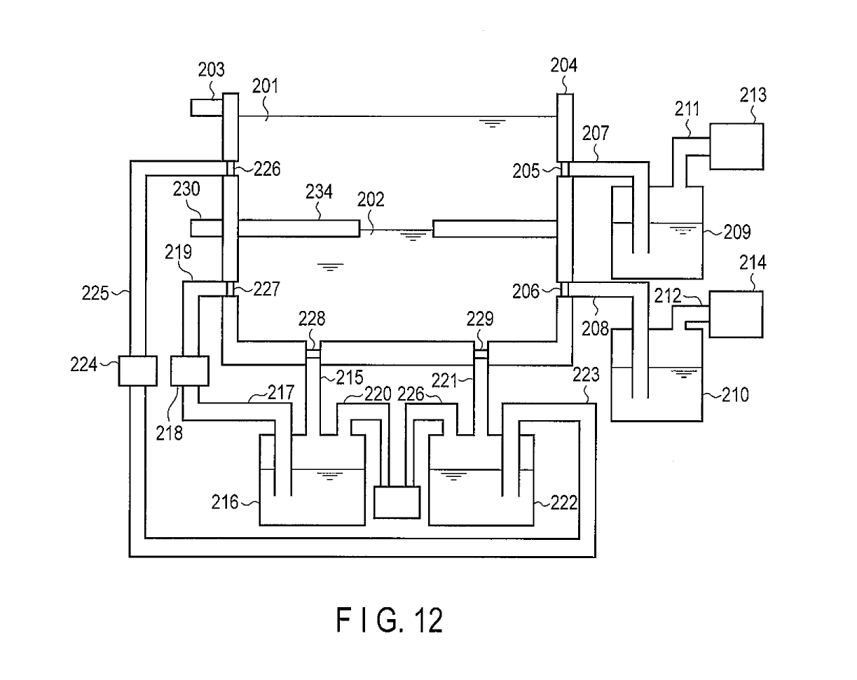

FIG. 12 shows another example of the arrangement of the cleaning apparatus applicable to the embodiment.

As shown in FIG. 12, a filter 234 for preventing the movement of dust particles liberated in each solvent can further be installed in the main body vessel 204. The filter 234 is a filter unit obtained by integrating a filter and its support member. When using solvents having a small solubility parameter difference, the interface between the separated solvents is unclear. This filter can decrease the movement of dust particles when the separated solvent interface moves, thereby suppressing redeposition to a sample.

When installing the filter 234 in the main body vessel 204, various combinations can be applied. For example, the affinity to each solvent can be either high or low, or filters having both high and low affinities can also be combined. The internal pore size of the filter can be a size with which dust particles can sufficiently be filtered. This filter has a space in which a sample can vertically move, and each solvent also vertically moves in this portion alone. Since the filter interferes with the vertical movement of the solvent in other portions, the movement of dust particles extremely decreases.

After separated solvents are filled in the main body vessel 204, removal can be performed by dipping a sample. As shown in FIG. 11, the sample is held by a holding jig 233, and passed through the solvent interface by vertical movement performed by a moving unit 231. As described previously, when the sample leaves and returns in the solvents, the release layer dissolves, and the mask is physically removed by the solvents. Consequently, these layers can be removed from the surface of the magnetic recording layer.

The sample moving unit 231 is electronically or manually controllable. The moving unit 231 includes the jig 233 for holding a sample, and also includes a mechanism 232 that extends into the solvents.

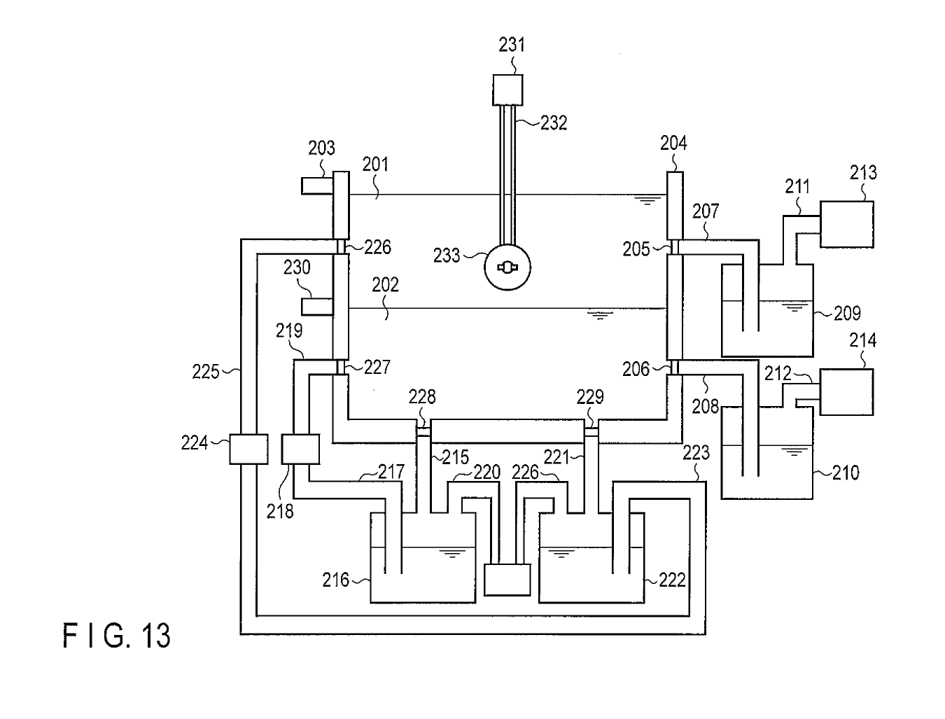

FIG. 13 is a view showing a part of the operation of the cleaning apparatus shown in FIG. 11.

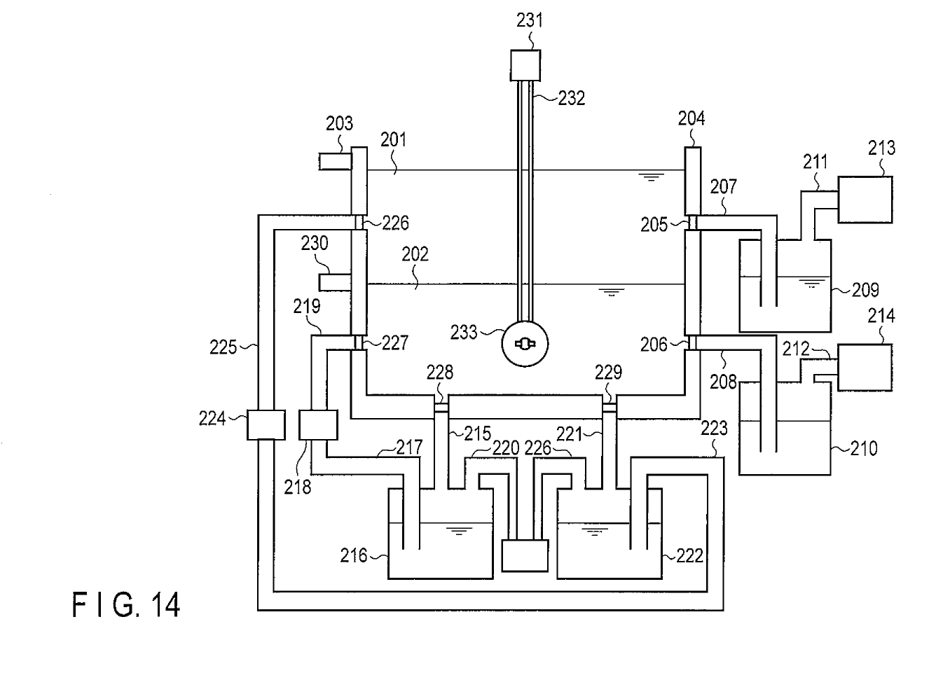

FIG. 14 is a view showing another part of the operation of the cleaning apparatus shown in FIG. 11.

As shown in FIGS. 13 and 14, removal can be performed as described above by vertically moving a sample in the solvents such that the sample leaves and returns in the solvents.

It is also possible to form a plurality of identical holding jigs 233 and connect them to the moving unit 231. This makes it possible to dip a plurality of samples in the solvents in the main body vessel 204, thereby increasing the number of samples to be processed.

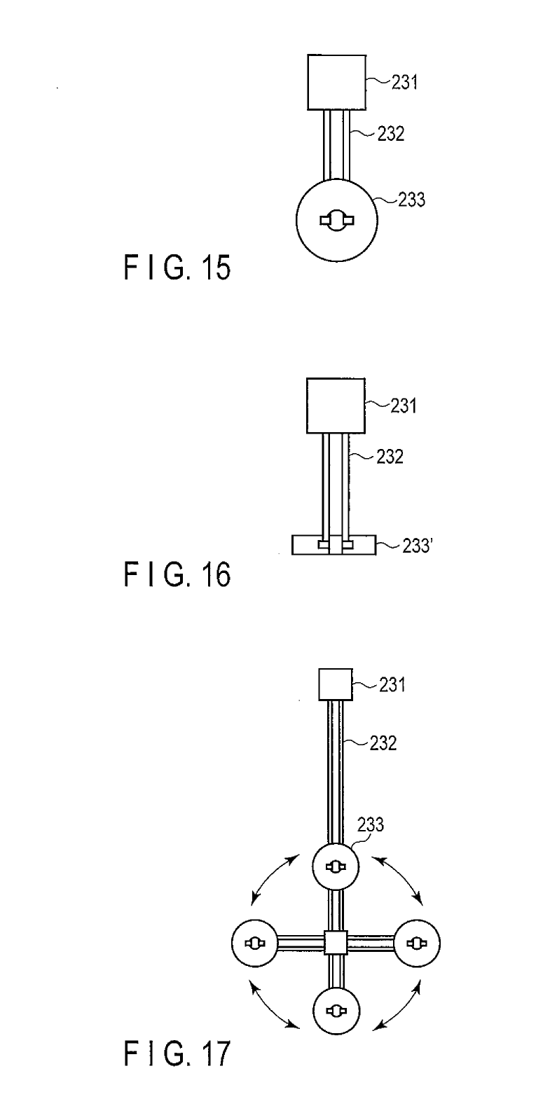

FIG. 15 is a view showing an example of a mechanism for loading a sample into the cleaning apparatus.

FIG. 16 is a view showing another example of the mechanism for loading a sample into the cleaning apparatus.

FIG. 17 is a view showing still another example of the mechanism for loading a sample into the cleaning apparatus.

Also, various methods can be applied to hold a sample. Examples are a method of dipping a sample as shown in FIG. 15, and a method of dipping a sample by changing an angle so that the pattern surface of the sample opposes the solvent surface as shown in FIG. 16. When opposing the pattern surface to the solvent, the angle can freely be set. Furthermore, as shown in FIG. 17, it is possible to use a mechanism that fixes a plurality of samples to a holding jig, and rotates the samples in the solvents. Removal using an apparatus can be performed as described above. Since the speed of the vertical movement of a sample is more uniform than that in an artificial method, it is possible to obtain a medium whose removal unevenness is more suppressed. It is also possible to reduce the manufacturing cost because a plurality of samples can be processed.

### EXAMPLES

The embodiments will be explained in more detail below by way of their examples.

### Example 1

First, a magnetic recording layer was formed on a doughnut substrate having a diameter of 2.5 inches by DC sputtering. That is, the magnetic recording layer was obtained by sequentially depositing a 10-nm thick NiTa base layer/4-nm thick Pd base layer/20-nm thick Ru base layer/5-nm thick CoPt recording layer from the substrate side, and finally forming a 3-nm thick Pd protective layer, by setting the gas pressure at 0.7 Pa and the input power at 500 W.

Subsequently, a release layer was formed on the magnetic recording layer. A Mo metal film was used as the release layer, and the layer was deposited to have a thickness of 3 nm by DC sputtering. This deposition was performed at an Ar gas pressure of 0.7 Pa and an input power of 500 W.

Subsequently, a mask layer was formed on the release layer. In this example, two mask layers were used to precisely transfer the three-dimensional patterns of a resist layer. That is, 30-nm thick C and 5-nm thick Si were applied from the substrate side. Each mask layer was deposited by sputtering at an Ar gas flow rate of 35 sccm, an Ar gas pressure of 0.3 Pa, and an input power of 500 W by using a facing target DC sputtering apparatus.

Then, a main chain scission type electron beam positive resist for patterning was deposited. ZEP-520A available from ZEON was used as the electron beam resist, and a solution was prepared by diluting the resist by using anisole (SP value: 9.3) as a solvent at a weight ratio of 1:3. After that, the substrate was spin-coated with the solution by setting the rotational speed at 2,500 rpm. The sample was held at 180° C. and prebaked for 180 sec by using a vacuum hotplate, thereby curing the electron beam resist.

Then, patterns were written on the electron beam resist by using an electron beam lithography apparatus including a ZrO thermal-field-emission electron source, and a beam having an acceleration voltage of 100 kV and a beam diameter of 3 nm. The electron beam lithography apparatus was a so-called, x-θ lithography apparatus including a signal for forming writing patterns, and a unidirectional moving mechanism and rotating mechanism of a sample stage. When performing lithography on the sample, a signal for deflecting an electron beam was synchronized, and the stage was moved in the radial direction. In this example, latent images of dot/space patterns and line/space patterns having a pitch of 20 nm were formed on the electron beam resist by setting the writing linear speed at 0.15 m/s, the beam current value at 13 nA, and the radial-direction feed amount at 5 nm.

By developing the latent images, it was possible to resolve three-dimensional patterns having 10-nm diameter dots/10-nm spaces and 10-nm wide lines/10-nm wide spaces. That is, an organic developer containing 100% normal amyl acetate was used as a developer, and the electron beam resist was developed by dipping it in the developer for 20 sec.

Note that it was also possible to use two-phase-separated solvents in the same manner as when removing the release layer. More specifically, development was performed in solvents separated into two layers by using water as a first solvent and 100% normal amyl acetate as a second solvent. The volume of each solution was 400 mL. First, the sample was held for 20 sec in normal amyl acetate in the upper layer as the second solvent, and moved to water in the lower layer as the first solvent through the solution interface. As the solvent moved through the solution interface, the mask on the sample surface was uniformly removed, and no dust particles were redeposited because they were liberated in the second solvent. The second solvent was discarded when pulling up the sample, and the sample was collected from the vessel containing only the first solvent. The sample was then rinsed as it was dipped in isopropylalcohol for 20 sec, and the sample surface was dried by direct blow of N₂.

Subsequently, the three-dimensional patterns of the resist layer were transferred to the mask layer. In this pattern transfer, inductively coupled plasma etching using CF₄ gas and O₂ gas was applied. First, etching was performed for 40 sec at a CF₄ gas pressure of 0.1 Pa, a gas flow rate of 20 sccm, an input power of 100 W, and a bias power of 10 W in order to remove the Si film below the resist, thereby transferring the resist patterns. Subsequently, the C film was etched for 65 sec by using O₂ gas at a gas pressure of 0.1 Pa, a gas flow rate of 20 sccm, an input power of 100 W, and a bias power of 20 W, thereby transferring the patterns.

Then, the three-dimensional patterns were transferred to the release layer and magnetic recording layer. As described previously, three-dimensional pattern transfer to the release layer and magnetic recording layer can be performed by different etching steps, and can also be performed by the same step. In this example, Ar ion milling was applied. Milling was performed for 120 sec at an Ar ion acceleration voltage of 300 V, a gas flow rate of 3 sccm, and a process pressure of 0.1 Pa, thereby transferring the three-dimensional patterns to the 3-nm thick Mo release layer, 3-nm thick Pd protective layer, and 5-nm thick CoPt magnetic film.

Subsequently, wet removal for removing the mask patterns was performed. As described above, a two-layer-separated release solution using a hydrogen peroxide solution capable of dissolving Mo as the first solvent and anisole as the second solvent was prepared. The concentration of the hydrogen peroxide solution was set at 0.5 wt %. The sample was first dipped in the first solvent for 3 min, and then moved up and down a plurality of number of times as it passed through the solvent interface, thereby dissolving the Mo layer and removing it from the surface of the magnetic recording layer. Anisole as the second solvent was drained from the vessel when pulling up the sample, and the sample was collected while suppressing the redeposition of dust particles.

Finally, a magnetic recording medium was obtained by depositing a 2-nm thick DLC film, and forming a 1.5-nm thick perfluoropolyether-based lubricating film after that.

A floating test was conducted by measuring the obtained magnetic recording medium by a glide height tester. Consequently, the medium was able to pass 9 nm as a standard required to perform read/write evaluation.

### Example 2

Example 2 was the same as Example 1 except that instead of using ZEP-520A as a resist layer and performing patterning by electron beam lithography, a micro phase-separated structure was formed by using a self-organized film, etching was performed based on micro phase-separated patterns, and a carbon film was inserted between the self-organized film and a mask layer in order to improve pattern transfer to the self-organized film.

First, a 3-nm thick pattern transfer carbon film was deposited on an Si mask. This deposition was performed by DC sputtering at an Ar gas pressure of 0.7 Pa and an input power of 500 W.

Subsequently, the transfer layer was coated with a block copolymer solution. As the block copolymer solution, a solution prepared by dissolving a block copolymer containing polystyrene and polydimethylsiloxane in a coating solvent was used. The molecular weights of polystyrene and polydimethylsiloxane were respectively 11,700 and 2,900. In addition, a polymer solution was prepared at a concentration of 1.5 wt. % by using anisole as a solvent. The mask was spin-coated with this solution at a rotational speed of 5,000 rpm, thereby depositing a single-layered, self-organized film. Furthermore, thermal annealing was performed to cause micro phase separation of polydimethylsiloxane dot patterns and a polystyrene matrix inside the self-organized film. This thermal annealing was performed at 170° C. for 12 hrs in a reduced-pressure ambient at an internal pressure of 0.2 Pa by using a vacuum heating furnace, thereby forming a micro phase-separated structure having a dot pitch of 20 nm inside the self-organized film.

Subsequently, three-dimensional patterns were formed by etching based on the phase-separated patterns. This etching was performed by inductively coupled plasma reactive ion etching. The process gas pressure was set at 0.1 Pa, and the gas flow rate was set at 5 sccm. First, to remove polydimethylsiloxane in the surface layer of the self-organized film, etching was performed for 7 sec by using CF₄ gas as an etchant at an antenna power of 50 W and a bias power of 5 W. Then, to transfer the three-dimensional patterns to the polystyrene matrix and to the C transfer layer below the polymer layer, etching was performed for 110 sec by using O₂ gas as an etchant at an antenna power of 100 W and a bias power of 5 W. Since the O₂ etchant for removing polystyrene also etched the C mask as a lower layer, etching stopped at the Si metal mask layer as a stopper layer. Subsequently, the three-dimensional patterns were transferred to the lower C/Si layer by plasma etching using the CF₄ etchant and O₂ etchant, thereby obtaining the three-dimensional patterns of the self-organized film on the carbon mask.

After that, a magnetic recording medium having the three-dimensional patterns was obtained by performing pattern transfer and a removing step in the same manner as in Example 1. A floating test was conducted by measuring the obtained magnetic recording medium by a glide height tester. Consequently, the medium was able to pass 9 nm as a standard required to perform read/write evaluation.

### Example 3

Example 3 was the same as Example 1 except that a nanoimprinting resist was used as a resist layer and three-dimensional patterns were formed by using a nanoimprinting stamper, instead of using ZEP-520A as a resist layer and forming three-dimensional patterns by electron beam lithography.

First, to manufacture a nanoimprinting stamper, a master template was manufactured. That is, a versatile 6-inch Si wafer was used as a substrate, and a carbon mask layer/Si mask layer were formed in the same manner as in Example 1. Then, an electron beam resist layer was formed, and 20-nm pitch dot patterns were formed by electron beam lithography. Note that the electron beam resist on the master template was developed by using a phase-separated release solution in the same manner as in Example 1. In the release solution, water was used as a first solvent, and isoamyl acetate was used as a second solvent.

A nanoimprinting stamper was manufactured using this master template. First, to perform conduction processing on three-dimensional patterns, a Ni film was deposited by DC sputtering. That is, the three-dimensional patterns were coated with a 5-nm thick Ni film at an ultimate vacuum degree of 8.0×10⁻⁴ Pa, an Ar gas pressure of 1.0 Pa, and a DC input power of 200 W. As the conductive film formation method, it is also possible to use a Ni—P alloy or Ni—B alloy formed by deposition or electroless plating, instead of sputtering. Furthermore, to facilitate releasing the stamper, the surface of the conductive film may also be oxidized. Subsequently, a Ni film was formed along the three-dimensional patterns by electroforming. A high-concentration nickel sulfamate plating solution (NS-169) available from Showa Chemical was used as an electroforming solution. A 300-μm thick Ni stamper was manufactured at a solution temperature of 55° C., a pH of 3.8 to 4.0, and a supplied current density of 20 A/dm² as electroforming conditions by using 600 g/L of nickel sulfamate, 40 g/L of boric acid, and 0.15 g/L of a sodium lauryl sulfate surfactant. A nanoimprinting stamper having three-dimensional patterns was obtained by releasing this Ni stamper from the master template. If a residue or particles exist on the stamper three-dimensional structure after release, the stamper can be cleaned by removing the residue or particles by performing etching as needed.

Finally, a Ni stamper was obtained by punching the electroformed Ni plate into a 2.5-inch circular disk. A resin stamper was duplicated by injection molding by using this Ni stamper. A cyclic olefin polymer (ZEONOR 1060R) available from ZEON was used as the resin material.

Three-dimensional patterns were formed in the resist layer by using the resin stamper obtained as described above.

First, a sample was spin-coated with a 40-nm thick ultraviolet-curing resist as a resist layer. Then, the above-mentioned resin stamper was imprinted on the resist layer, and the resist layer was cured by irradiation with ultraviolet light (ultraviolet light was emitted while the ultraviolet-curing resin layer was pressed by the resin stamper). Desired 20-nm pitch dot patterns were obtained by releasing the resin stamper from the cured resist layer.

A resist residue formed in the grooves of the three-dimensional patterns by imprinting was removed by etching. This removal of the resist residue was done by plasma etching using an O₂ etchant. That is, the resist residue was removed by performing etching for 8 sec at an O₂ gas flow rate of 20 sccm, a pressure of 0.1 Pa, an input power of 100 W, and a bias power of 20 W. The three-dimensional patterns of the resist layer were thus formed on the sample including the magnetic recording layer. After that, a magnetic recording medium having the three-dimensional patterns was obtained by performing pattern transfer and a removing step in the same manner as in Example 1. A floating test was conducted by measuring the obtained magnetic recording medium by a glide height tester. Consequently, the medium was able to pass 9 nm as a standard required to perform read/write evaluation.

### Example 4

Example 4 was the same as Example 1 except that phenetole (SP value: 9) was used as the second solvent.

In a removing process, a release solution was prepared by mixing and separating 400 mL of a 0.5-wt. % hydrogen peroxide solution and 400 mL of phenetole. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium was able to pass 9 nm as a standard required to perform read/write evaluation.

### Example 5

Example 5 was the same as Example 1 except that cyclohexane (SP value: 8.2) was used as the second solvent.

In a removing process, a release solution was prepared by mixing and separating 400 mL of a 0.5-wt. % hydrogen peroxide solution and 400 mL of cyclohexane. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium was able to pass 9 nm as a standard required to perform read/write evaluation.

### Example 6

Example 6 was the same as Example 1 except that methylcyclohexane (SP value: 7.8) was used as the second solvent.

In a removing process, a release solution was prepared by mixing and separating 400 mL of a 0.5-wt. % hydrogen peroxide solution and 400 mL of methylcyclohexane. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium was able to pass 9 nm as a standard required to perform read/write evaluation.

### Example 7

Example 7 was the same as Example 1 except that diethyl malonate (SP value: 9.1) was used as the first solvent, and a hydrogen peroxide solution was used as the second solvent.

In a removing process, a release solution was prepared by mixing and separating 400 mL of a 0.5-wt. % hydrogen peroxide solution and 400 mL of diethyl malonate. Since the specific gravity of diethyl malonate is larger than 1, diethyl malonate separated into the lower phase as the first solvent. When pulling up a sample, no dust particles were liberated in the second solvent, so the sample was collected without draining the second solvent. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 8

Example 8 was the same as Example 1 except that xylene (SP value: 8.8) was used as the second solvent.

In a removing process, a release solution was prepared by mixing and separating 400 mL of a 0.5-wt. % hydrogen peroxide solution and 400 mL of xylene. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium could pass 9 nm as a standard required to perform read/write evaluation.

### Example 9

Example 9 was the same as Example 1 except that isoamyl acetate (SP value: 8.45) was used as the second solvent.

In a removing process, a release solution was prepared by mixing and separating 400 mL of a 0.5-wt. % hydrogen peroxide solution and 400 mL of isoamyl acetate. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium could pass 9 nm as a standard required to perform read/write evaluation.

### Example 10

Example 10 was the same as Example 1 except that normal amyl acetate (SP value: 8.6) was used as the second solvent.

In a removing process, a release solution was prepared by mixing and separating 400 mL of a 0.5-wt. % hydrogen peroxide solution and 400 mL of normal amyl acetate. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium could pass 9 nm as a standard required to perform read/write evaluation.

### Example 11

Example 11 was the same as Example 1 except that toluene (SP value: 8.8) was used as the second solvent.

In a removing process, a release solution was prepared by mixing and separating 400 mL of a 0.5-wt. % hydrogen peroxide solution and 400 mL of toluene. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium could pass 9 nm as a standard required to perform read/write evaluation.

### Example 12

Example 12 was the same as Example 1 except that hexane (SP value: 7.3) was used as the second solvent.

In a removing process, a release solution was prepared by mixing and separating 400 mL of a 0.5-wt. % hydrogen peroxide solution and 400 mL of hexane. After that, a magnetic recording medium having three-dimensional patterns was obtained through pattern transfer and a removing step in the same manner as in Example 1. A floating test was conducted by measuring the obtained magnetic recording medium by a glide height tester. Consequently, the medium could pass 9 nm as a standard required to perform read/write evaluation.

### Example 13

Example 13 was the same as Example 1 except that an AlBN alloy was used as the release layer, a sodium hydroxide solution was used as the first solvent, and anisole was used as the second solvent.

A 3-nm thick AlBN alloy as the release layer was deposited by sputtering at an Ar gas flow rate of 35 sccm, an Ar gas pressure of 0.3 Pa, and an input power of 500 W by using a facing target DC sputtering apparatus.

Pattern transfer to the release layer and magnetic recording layer was performed by ion milling. This milling was performed for 130 sec at an Ar ion acceleration voltage of 300 V, a gas flow rate of 3 sccm, and a process pressure of 0.1 Pa, thereby transferring the three-dimensional patterns to the 3-nm thick AlBN release layer, 3-nm thick Pd protective layer, and 5-nm thick CoPt magnetic film.

Subsequently, wet removal for removing the mask patterns was performed. As described above, a two-phase-separated release solution using a sodium hydroxide solution capable dissolving AlBN as the first solvent and anisole as the second solvent was prepared. The concentration of the sodium hydroxide solution was set at 0.01 wt. %. The sample was first dipped in the first solvent for 3 min, and then moved up and down a plurality of number of times so as to pass through the solvent interface, thereby dissolving the AlBN layer and removing it from the surface of the magnetic recording layer. When pulling up the sample, the sample was moved to anisole as the second solvent, and collected while the redeposition of dust particles was suppressed.

After that, a magnetic recording medium having the three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 14

Example 14 was the same as Example 13 except that phenetole was used as the second solvent.

In a removing process, a release solution was prepared by mixing and separating 400 mL of a 0.01-wt. % sodium hydroxide solution and 400 mL of phenetole. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 15

Example 15 was the same as Example 13 except that cyclohexane was used as the second solvent.

In a removing process, a release solution was prepared by mixing and separating 400 mL of a 0.01-wt. % sodium hydroxide solution and 400 mL of cyclohexane. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 16

Example 16 was the same as Example 13 except that methylcyclohexane was used as the second solvent.

In a removing process, a release solution was prepared by mixing and separating 400 mL of a 0.01-wt. % sodium hydroxide solution and 400 mL of methylcyclohexane. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 17

Example 17 was the same as Example 13 except that diethyl malonate was used as the first solvent, and a sodium hydroxide solution was used as the second solvent.

In a removing process, a release solution was prepared by mixing and separating 400 mL of a 0.01-wt. % sodium hydroxide solution and 400 mL of diethyl malonate. Since the specific gravity of diethyl malonate is larger than 1, diethyl malonate separated into the lower phase as the first solvent. When pulling up a sample, no dust particles were liberated in the second solvent, so the sample was collected without draining the second solvent. After that, a magnetic recording medium having three-dimensional patterns was obtained through pattern transfer and a removing step in the same manner as in Example 7. A floating test was conducted by measuring the obtained magnetic recording medium by a glide height tester. Consequently, the medium was able to pass 9 nm as a standard required to perform read/write evaluation.

### Example 18

Example 18 was the same as Example 13 except that xylene was used as the second solvent.

In a removing process, a release solution was prepared by mixing and separating 400 mL of a 0.01-wt. % sodium hydroxide solution and 400 mL of xylene. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 19

Example 19 was the same as Example 13 except that isoamyl acetate was used as the second solvent.

In a removing process, a release solution was prepared by mixing and separating 400 mL of a 0.01-wt. % sodium hydroxide solution and 400 mL of isoamyl acetate. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 20

Example 20 was the same as Example 13 except that normal amyl acetate was used as the second solvent.

In a removing process, a release solution was prepared by mixing and separating 400 mL of a 0.01-wt. % sodium hydroxide solution and 400 mL of normal amyl acetate. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 21

Example 21 was the same as Example 13 except that toluene was used as the second solvent.

In a removing process, a release solution was prepared by mixing and separating 400 mL of a 0.01-wt. % sodium hydroxide solution and 400 mL of toluene. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 22

Example 22 was the same as Example 13 except that hexane was used as the second solvent.

In a removing process, a release solution was prepared by mixing and separating 400 mL of a 0.01-wt. % sodium hydroxide solution and 400 mL of hexane. After that, a magnetic recording medium having three-dimensional patterns was obtained through pattern transfer and a removing step in the same manner as in Example 13. A floating test was conducted by measuring the obtained magnetic recording medium by a glide height tester. Consequently, the medium was able to pass 9 nm as a standard required to perform read/write evaluation.

### Example 23

Example 23 was the same as Example 1 except that an organic resist was used as the release layer, anisole was used as the second solvent, and water was used as the first solvent. PMMA was selected as the release layer, and the layer was formed to have a thickness of 3 nm on the magnetic recording layer.

In a removing process, a release solution was prepared by mixing and separating 400 mL of pure water and 400 mL of anisole. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 24

Example 24 was the same as Example 1 except that an organic resist was used as the release layer, phenetole was used as the second solvent, and water was used as the first solvent. PMMA was selected as the release layer, and the layer was formed to have a thickness of 3 nm on the magnetic recording layer.

In a removing process, a release solution was prepared by mixing and separating 400 mL, of pure water and 400 mL, of phenetole. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 25

Example 25 was the same as Example 1 except that an organic resist was used as the release layer, cyclohexane was used as the second solvent, and water was used as the first solvent. PVA was selected as the release layer, and the layer was formed to have a thickness of 3 nm on the magnetic recording layer.

In a removing process, a release solution was prepared by mixing and separating 400 mL of pure water and 400 mL of cyclohexane. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 26

Example 26 was the same as Example 1 except that an organic resist was used as the release layer, methylcyclohexane was used as the second solvent, and water was used as the first solvent. PVA was selected as the release layer, and the layer was formed to have a thickness of 3 nm on the magnetic recording layer.

In a removing process, a release solution was prepared by mixing and separating 400 mL of pure water and 400 mL of methylcyclohexane. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 27

Example 27 was the same as Example 1 except that an organic resist was used as the release layer, diethyl malonate was used as the first solvent, and water was used as the second solvent. PMMA was selected as the release layer, and the layer was formed to have a thickness of 3 nm on the magnetic recording layer.

In a removing process, a release solution was prepared by mixing and separating 400 mL of pure water and 400 mL of diethyl malonate. When pulling up a sample after removal was performed by the first solvent, the sample was collected without draining the second solvent because no dust particles were liberated in the second solvent. After that, a magnetic recording medium having three-dimensional patterns was obtained in the same manner as in Example 7. A floating test was conducted by measuring the obtained magnetic recording medium by a glide height tester. Consequently, the medium was able to pass 9 nm as a standard required to perform read/write evaluation.

### Example 28

Example 28 was the same as Example 1 except that an organic resist was used as the release layer, xylene was used as the second solvent, and water was used as the first solvent. PE was selected as the release layer, and the layer was formed to have a thickness of 3 nm on the magnetic recording layer.

In a removing process, a release solution was prepared by mixing and separating 400 mL of pure water and 400 mL of xylene. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 29

Example 29 was the same as Example 1 except that an organic resist was used as the release layer, isoamyl acetate was used as the second solvent, and water was used as the first solvent. PS was selected as the release layer, and the layer was formed to have a thickness of 3 nm on the magnetic recording layer.

In a removing process, a release solution was prepared by mixing and separating 400 mL of pure water and 400 mL of isoamyl acetate. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 30

Example 30 was the same as Example 1 except that an organic resist was used as the release layer, normal amyl acetate was used as the second solvent, and water was used as the first solvent. PS was selected as the release layer, and the layer was formed to have a thickness of 3 nm on the magnetic recording layer.

In a removing process, a release solution was prepared by mixing and separating 400 mL of pure water and 400 mL of normal amyl acetate. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 31

Example 31 was the same as Example 1 except that an organic resist was used as the release layer, toluene was used as the second solvent, and water was used as the first solvent. PS was selected as the release layer, and the layer was formed to have a thickness of 3 nm on the magnetic recording layer.

In a removing process, a release solution was prepared by mixing and separating 400 mL of pure water and 400 mL of toluene. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Example 32

Example 32 was the same as Example 1 except that an organic resist was used as the release layer, hexane was used as the second solvent, and water was used as the first solvent. PS was selected as the release layer, and the layer was formed to have a thickness of 3 nm on the magnetic recording layer.

In a removing process, a release solution was prepared by mixing and separating 400 mL of pure water and 400 mL of hexane. After removal was performed by the first solvent, the solvent was drained from the vessel, and a sample was collected while the redeposition of dust particles was reduced. After that, a magnetic recording medium having three-dimensional patterns was obtained in the same manner as in Example 1. A floating test was conducted by measuring the obtained magnetic recording medium by a glide height tester. Consequently, the medium was able to pass 9 nm as a standard required to perform read/write evaluation.

### Comparative Example 1

Comparative Example 1 was the same as Example 1 except that a hydrogen peroxide solution alone was used as the release solution. In a removing process, 400 mL of a hydrogen peroxide solution was used as the release solution. After that, a magnetic recording medium having three-dimensional patterns was obtained in the same manner as in Example 1. A floating test was conducted by measuring the obtained magnetic recording medium by a glide height tester. Consequently, the medium could not pass 9 nm as a standard required to perform read/write evaluation, and the floating amount was 15 nm.

### Comparative Example 2

Comparative Example 2 was the same as Example 13 except that a sodium hydroxide solution alone was used as the release solution. In a removing process, 400 mL of a sodium hydroxide solution was used as the release solution. After that, a magnetic recording medium having three-dimensional patterns was obtained in the same manner as in Example 13. A floating test was conducted by measuring the obtained magnetic recording medium by a glide height tester. Consequently, the medium could not pass 9 nm as a standard required to perform read/write evaluation, and the floating amount was 12 nm.

### Comparative Example 3

Comparative Example 3 was the same as Example 23 except that an anisole alone was used as the release solution. In a removing process, 400 mL of anisole was used as the release solution. After that, a magnetic recording medium having three-dimensional patterns was obtained in the same manner as in Example 23. A floating test was conducted by measuring the obtained magnetic recording medium by a glide height tester. Consequently, the medium could not pass 9 nm as a standard required to perform read/write evaluation, and the floating amount was 14 nm.

Tables 1 and 2 below show the solvents used in the phase-separated release solutions and the release layers in Examples 1 to 32 and Comparative Examples 1 to 3.

TABLE 1

| | | Removing | Solvent | Solvent | Phase for | SP | Specific | Release | Head | |
|---|---|---|---|---|---|---|---|---|---|---|
| | | process | (lower phase) | (upper phase) | dissolution | value | gravity | layer | floating | Patterning |
| Example | 1 | Acid | H₂O₂ | Anisole | Lower phase | 9.3 | 0.99 | Mo | 9 nm OK | Lithography |
| | | | | | dissolution | | | | | |
| | 2 | Acid | H₂O₂ | Anisole | Lower phase | 9.3 | 0.99 | Mo | 9 nm OK | Self-organization |
| | | | | | dissolution | | | | | |
| | 3 | Acid | H₂O₂ | Anisole | Lower phase | 9.3 | 0.99 | Mo | 9 nm OK | Nanoimprinting |
| | | | | | dissolution | | | | | |
| | 4 | Acid | H₂O₂ | Phenetole | Lower phase | 9 | 0.96 | Mo | 9 nm OK | Lithography |
| | | | | | dissolution | | | | | |
| | 5 | Acid | H₂O₂ | Cyclohexane | Lower phase | 8.2 | 0.78 | Mo | 9 nm OK | ″ |
| | | | | | dissolution | | | | | |
| | 6 | Acid | H₂O₂ | Methylcyclohexane | Lower phase | 7.8 | 0.77 | Mo | 9 nm OK | ″ |
| | | | | | dissolution | | | | | |
| | 7 | Acid | Diethyl | H₂O₂ | Upper phase | 9.1 | 1.06 | Mo | 9 nm OK | ″ |
| | | | malonate | | dissolution | | | | | |
| | 8 | Acid | H₂O₂ | Xylene | Lower phase | 8.8 | 0.86 | Mo | 9 nm OK | ″ |
| | | | | | dissolution | | | | | |
| | 9 | Acid | H₂O₂ | Isoamyl acetate | Lower phase | 8.45 | 0.88 | Mo | 9 nm OK | ″ |
| | | | | | dissolution | | | | | |
| | 10 | Acid | H₂O₂ | Normal amyl | Lower phase | 8.6 | 0.88 | Mo | 9 nm OK | ″ |
| | | | | acetate | dissolution | | | | | |
| | 11 | Acid | H₂O₂ | Toluene | Lower phase | 8.8 | 0.87 | Mo | 9 nm OK | ″ |
| | | | | | dissolution | | | | | |
| | 12 | Acid | H₂O₂ | Hexane | Lower phase | 7.3 | 0.66 | Mo | 9 nm OK | ″ |
| | | | | | dissolution | | | | | |
| | 13 | Alkali | NaOH | Anisole | Lower phase | 9.3 | 0.99 | AIBN | 9 nm OK | ″ |
| | | | | | dissolution | | | | | |
| | 14 | Alkali | NaOH | Phenetole | Lower phase | 9 | 0.96 | AIBN | 9 nm OK | ″ |
| | | | | | dissolution | | | | | |
| | 15 | Alkali | NaOH | Cyclohexane | Lower phase | 8.2 | 0.78 | AIBN | 9 nm OK | ″ |
| | | | | | dissolution | | | | | |
| | 16 | Alkali | NaOH | Methylcyclohexane | Lower phase | 7.8 | 0.77 | AIBN | 9 nm OK | ″ |
| | | | | | dissolution | | | | | |
| | 17 | Alkali | Diethyl | NaOH | Upper phase | 9.1 | 1.06 | AIBN | 9 nm OK | ″ |
| | | | malonate | | dissolution | | | | | |
| | 18 | Alkali | NaOH | Xylene | Lower phase | 8.8 | 0.86 | AIBN | 9 nm OK | ″ |
| | | | | | dissolution | | | | | |
| | 19 | Alkali | NaOH | Isoamyl acetate | Lower phase | 8.45 | 0.88 | AIBN | 9 nm OK | ″ |
| | | | | | dissolution | | | | | |
| | 20 | Alkali | NaOH | Normal amyl | Lower phase | 8.6 | 0.88 | AIBN | 9 nm OK | ″ |
| | | | | acetate | dissolution | | | | | |
| | 21 | Alkali | NaOH | Toluene | Lower phase | 8.8 | 0.87 | AIBN | 9 nm OK | ″ |
| | | | | | dissolution | | | | | |
| | 22 | Alkali | NaOH | Hexane | Lower phase | 7.3 | 0.66 | AIBN | 9 nm OK | ″ |
| | | | | | dissolution | | | | | |

TABLE 2

| | | Removing | Solvent | Solvent | Phase for | SP | Specific | Release | Head | | |
|---|---|---|---|---|---|---|---|---|---|---|---|
| | | process | (lower phase) | (upper phase) | dissolution | value | gravity | layer | floating | | Patterning |
| Example | 23 | Organic | Water | Anisole | Upper phase | 9.3 | 0.99 | PMMA | 9 | nm OK | Lithography |
| | | solvent | | | dissolution | | | | | | |
| | 24 | Organic | Water | Phenetole | Upper phase | 9 | 0.96 | PMMA | 9 | nm OK | ″ |
| | | solvent | | | dissolution | | | | | | |
| | 25 | Organic | Water | Cyclohexane | Upper phase | 8.2 | 0.78 | PVA | 9 | nm OK | ″ |
| | | Solvent | | | dissolution | | | | | | |
| | 26 | Organic | Water | Methylcyclohexane | Upper phase | 7.8 | 0.77 | PVA | 9 | nm OK | ″ |
| | | solvent | | | dissolution | | | | | | |
| | 27 | Organic | Diethyl | Water | Lower phase | 9.1 | 1.06 | PMMA | 9 | nm OK | ″ |
| | | solvent | malonate | | dissolution | | | | | | |
| | 28 | Organic | Water | Xylene | Upper phase | 8.8 | 0.86 | PE | 9 | nm OK | ″ |
| | | solvent | | | dissolution | | | | | | |
| | 29 | Organic | Water | Isoamyl acetate | Upper phase | 8.45 | 0.88 | PS | 9 | nm OK | ″ |
| | | solvent | | | dissolution | | | | | | |
| | 30 | Organic | Water | Normal amyl | Upper phase | 8.6 | 0.88 | PS | 9 | nm OK | ″ |
| | | solvent | | acetate | dissolution | | | | | | |
| | 31 | Organic | Water | Toluene | Upper phase | 8.8 | 0.87 | PS | 9 | nm OK | ″ |
| | | solvent | | | dissolution | | | | | | |
| | 32 | Organic | Water | Hexane | Upper phase | 7.3 | 0.66 | PS | 9 | nm OK | ″ |
| | | solvent | | | dissolution | | | | | | |
| Comparative | 1 | Acid | H₂O₂ | | | | | Mo | 15 | nm | |
| Example | | | | | | | | | (9 | nm NG) | |
| | 2 | Alkali | NaOH | | | | | AIBN | 12 | nm | |
| | | | | | | | | | (9 | nm NG) | |
| | 3 | Organic | Anisole | | | | | PMMA | 14 | nm | |
| | | solvent | | | | | | | (9 | nm NG) | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
forming a magnetic recording layer on a substrate;
forming a release layer on the magnetic recording layer;
forming a mask layer on the release layer;
forming a resist layer on the mask layer;
forming a three-dimensional pattern on the resist layer;
transferring the three-dimensional pattern to the mask layer;
transferring the three-dimensional pattern to the release layer;
transferring the three-dimensional pattern to the magnetic recording layer;
removing the release layer and removing layers remaining on the release layer by dipping the substrate in a first phase of a phase-separated release solution including the first phase containing a first solvent configured to dissolve the release layer, and a second phase containing a second solvent having a property of separating from the first solvent; and
moving the substrate to the second phase, thereby separating the substrate from the first phase containing the release layer and the layers remaining on the release layer.

2. The method according to claim 1, wherein the release layer is sparingly soluble in the second solvent.

3. The method according to claim 1, wherein the phase-separated release solution contains one of an acid solvent, an alkali solvent, and an organic solvent.

4. The method according to claim 1, wherein the resist layer is a self-organized film having at least two different types of polymer chains.

5. The method according to claim 1, wherein the three-dimensional pattern of the resist layer is formed by nanoimprinting.

6. The method according to claim 1, further comprising forming a pattern transfer layer between the mask layer and the resist layer.

7. A magnetic recording medium manufactured by a magnetic recording medium manufacturing method comprising:
forming a magnetic recording layer on a substrate;
forming a release layer on the magnetic recording layer;
forming a mask layer on the release layer;
forming a resist layer on the mask layer;
forming a three-dimensional pattern on the resist layer;
transferring the three-dimensional pattern to the mask layer;
transferring the three-dimensional pattern to the release layer;
transferring the three-dimensional pattern to the magnetic recording layer;
removing the release layer and removing layers remaining on the release layer by dipping the substrate in a first phase of a phase-separated release solution including the first phase containing a first solvent configured to dissolve the release layer, and a second phase containing a second solvent having a property of separating from the first solvent; and
moving the substrate to the second phase, thereby separating the substrate from the first phase containing the release layer and the layers remaining on the release layer.

8. The medium according to claim 7, wherein the release layer is sparingly soluble in the second solvent.

9. The medium according to claim 7, wherein the phase-separated release solution contains one of an acid solvent, an alkali solvent, and an organic solvent.

10. The medium according to claim 7, wherein the resist layer is a self-organized film having at least two different types of polymer chains.

11. The medium according to claim 7, wherein the three-dimensional pattern of the resist layer is formed by nanoimprinting.

12. The medium according to claim 7, wherein the method further comprises forming a pattern transfer layer between the mask layer and the resist layer.
